(19) United States
(12) Patent Application Publication
(10) Pub. No.: US 2026/0080433 A1
(43) Pub. Date: Mar. 19, 2026

(54) MARKETING INTEGRATION AND ANALYSIS PLATFORM

(71) Applicant: mktg.ai Inc., Larchmont, NY (US)

(72) Inventors: Kevin Wassong, Larchmont, NY (US); Arpit Agrawal, Belle Mead, NJ (US)

(21) Appl. No.: 19/330,285

(22) Filed: Sep. 16, 2025

Related U.S. Application Data
(60) Provisional application No. 63/695,007, filed on Sep. 16, 2024.

(51) Int. Cl. G06Q 30/0242; G06Q 30/0202; G06Q 30/0241

(52) U.S. Cl. CPC G06Q 30/0244; G06Q 30/02022; G06Q 30/0276

(57) ABSTRACT

A method includes receiving historical marketing data including historical creative assets and historical performance data associated with the historical creative assets. The method further includes processing the historical marketing data to identify input features associated with the historical creative assets. The method further includes using the identified input features and the historical performance data to train a machine learning model, thereby generating a trained marketing model conditioned to the input features and the historical performance data. The method further includes providing as an input to the trained marketing model, marketing data that includes at least one creative asset, a selection of a marketing channel for placement of the creative asset therein, and performance indicators for evaluating performance of the creative asset. The method further includes receiving, as an output from the trained marketing model, predicted values for the performance indicators upon placement of the creative asset on the marketing channel.

### CROSS-REFERENCE OF RELATED APPLICATION

This application claims the benefit of U.S. Provisional Application No. 63/695,007, filed on Sep. 16, 2024, and which is incorporated herein in its entirety.

### TECHNICAL FIELD

The present disclosure generally relates to marketing integration and analysis, and more particularly to applications for data visualization and decision making.

### BACKGROUND

Marketers struggle with an ever-changing portfolio of creative partners, technology providers, and analytics solutions, a sentiment echoed by a global analytics lead who lamented, “we are drowning in analytics.” With the growth of different media channels, complexity has accelerated. Creative and media channels have become siloes that compete for dollars and attention. The modern marketing landscape has exacerbated the complexity and expense of marketing efforts and building a brand.

As such, marketers desire the ability to seamlessly view all their creative assets, digital and non-digital alike, and evaluate performance both quantitatively and qualitatively in an intuitive simplistic way, so as to make marketing easier and repeatable for marketers and better for consumers. More importantly, marketers desire a way to normalize performance data across media channels where metrics and KPIs are radically different by channel, product category and brand.

### SUMMARY

Some embodiments of the present disclosure provide a method for optimizing performance of creative assets. The method includes receiving historical marketing data including historical creative assets and historical performance data associated with the historical creative assets. The method further includes processing the historical marketing data to identify input features associated with the historical creative assets. The method further includes using the identified input features and the historical performance data, and training a machine learning model, thereby generating a trained marketing model conditioned to the input features and the historical performance data. The method further includes providing as an input to the trained marketing model, marketing data including at least one creative asset, a selection of at least one marketing channel for placement of the at least one creative asset therein, and one or more performance indicators for evaluating performance of the at least one creative asset. The method further includes receiving as an output from the trained marketing model, predicted values for the one or more performance indicators upon placement of the at least one creative asset on the at least one marketing channel.

Some embodiments of the present disclosure provide a non-transitory computer-readable medium storing a program for optimizing performance of creative assets. The program, when executed by a computer, configures the computer to receive historical marketing data including historical creative assets and historical performance data associated with the historical creative assets. The program, when executed by a computer, further configures the computer to process the historical marketing data to identify input features associated with the historical creative assets. The program, when executed by a computer, further configures the computer to use the identified input features and the historical performance data to train a machine learning model, thereby generating a trained marketing model conditioned to the input features and the historical performance data. The program, when executed by a computer, further configures the computer to provide, as an input to the trained marketing model, marketing data comprising at least one creative asset, a selection of at least one marketing channel for placement of the at least one creative asset therein, and one or more performance indicators for evaluating performance of the at least one creative asset. The program, when executed by a computer, further configures the computer to receive, as an output from the trained marketing model, predicted values for the one or more performance indicators upon placement of the at least one creative asset on the at least one marketing channel.

Some embodiments of the present disclosure provide a system for optimizing performance of creative assets. The system comprises one or more processors and a non-transitory computer-readable medium storing a set of instructions, which when executed by at least one of the processors, configure the system to receive historical marketing data comprising a plurality of historical creative assets and historical performance data associated with the plurality of historical creative assets. The instructions, when executed by the processors, further configure the system to process the historical marketing data to identify a plurality of input features associated with the historical creative assets. The instructions, when executed by the processors, further configure the system to use the identified plurality of input features and the historical performance data to train a machine learning model, thereby generating a trained marketing model conditioned to the input features and the historical performance data. The instructions, when executed by the processors, further configure the system to provide, as an input to the trained marketing model, marketing data comprising at least one creative asset, a selection of at least one marketing channel for placement of the at least one creative asset therein, and one or more performance indicators for evaluating performance of the at least one creative asset. The instructions, when executed by the processors, further configure the system to receive, as an output from the trained marketing model, predicted values for the one or more performance indicators upon placement of the at least one creative asset on the at least one marketing channel.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture for performance visualization, according to some embodiments.

FIG. 2 is a block diagram illustrating details of a system for performance visualization, according to some embodiments.

FIG. 3 is a flowchart illustrating a process for performance visualization, according to some embodiments.

FIG. 4 is a block diagram illustrating an exemplary computer system with which aspects of the subject technology can be implemented.

FIG. 5 illustrates a system for creative asset management, according to some embodiments.

FIG. 6 illustrates a system illustrating performance analytics and visualization, according to some embodiments.

FIG. 7 illustrates a system for using generative artificial intelligence to generate creative assets, according to some embodiments.

FIG. 8 is a flowchart illustrating a process for performance visualization, according to some embodiments.

FIG. 9 is a flowchart illustrating a process for optimizing performance of creative assets, according to some embodiments.

FIG. 10 is a diagram illustrating a categorization of marketing channels, according to some embodiments.

FIG. 11 is a diagram illustrating a categorization of marketing channels, according to some embodiments.

FIG. 12 illustrates an example advertisement asset, according to some embodiments.

FIG. 13 illustrates a color scale used to normalize KPI performance into discrete ranges according to configurable thresholds, according to some embodiments.

FIGS. 14A and 14B illustrate an example user interface for defining performance thresholds for key performance indicators (KPIs), according to some embodiments.

FIG. 14C illustrates an alternative user interface for defining thresholds, according to some embodiments.

FIG. 15 illustrates an example of a heatmap for creative asset performance evaluation, according to some embodiments.

FIGS. 16A-16E show an example of a user interface for evaluating different scenarios of an asset's performance according to multiple KPIs, according to some embodiments.

FIG. 17 illustrates a performance breakdown of marketing assets by placement, according to some embodiments.

FIG. 18A and FIG. 18B illustrate an example of normalization for a creative asset, according to some embodiments.

FIG. 19A illustrates a heatmap of marketing channels, according to some embodiments.

FIG. 19B is a diagram illustrating the use of a normalized KPI framework to generate the heatmap shown in FIG. 19A, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Marketing performance may be driven by several factors, including but not limited to:

The creative asset—design, messaging, and format, including elements like imagery, tone, and emotional appeal, which directly influence audience engagement and response. Note that there are multiple asset types.

Media placement—Choice of channels, timing, frequency, and targeting to ensure the creative asset reaches the right audience at the right moment for maximum impact and audience. Note that there are multiple channels and agencies.

External Factors—Variables outside direct control, such as weather, cultural trends, news cycles, economic conditions, and competitor activity, which can significantly shape how the audience perceives and reacts to the creative asset.

One challenge why marketing performance cannot be measured across asset type, channel, agencies etc. is because each Key Performance Indicator (KPI) for measuring performance across each of those dimensions is different. As a non-limiting example, a marketer might measure the performance of a social media image advertisement by click-through rate (CTR) and might benchmark 5% CTR to be a good performance. At the same time, on a video sharing website, the same marketer might want to measure the performance of a video advertisement by “views” and might benchmark 100K views as good performance. On a search engine, the same marketer might want to benchmark cost-per-click (CPC) as the key KPI and might benchmark $0.05 as a good performance. Another marketer might measure the performance on these same channels completely differently. No standard benchmarks exist to measure performance across channels, agencies, asset types, etc.

Some embodiments provide a technical solution to a longstanding problem in marketing analytics: the inability to compare asset performance across heterogeneous marketing channels, asset types, and KPIs due to the lack of standardized computational benchmarks. Unlike conventional systems that rely on manual interpretation or siloed analytics, some embodiments provide a novel normalization framework that transforms disparate performance metrics into a normalized scale. This transformation is not merely a visual aid but requires a computational process that enables automated, scalable, and objective comparison across marketing dimensions. Some embodiments thereby improve the functioning of the computer itself by enabling it to perform tasks, including but not limited to cross-channel benchmarking, predictive modeling, and prescriptive analysis, that conventional data processing systems cannot perform.

Specifically, some embodiments improve the way computers store, process and interpret marketing performance data by providing a structured, algorithmic method for normalizing heterogenous performance metrics using configurable thresholds and multi-KPI aggregation logic. This enables the generation of actionable insights and predictive outputs that cannot be achieved through generic data processing or mental steps, and instead, provides a concrete advancement in data modeling and machine learning as applied to heterogenous performance metrics.

Embodiments described herein do not merely use a generic computer to perform conventional data analysis. Instead, they leverage computing resources to execute specialized operations, including but not limited to: dynamic threshold configuration based on user input and historical performance data; aggregating multi-dimensional KPIs; scoring creative assets using a normalized performance scale; extracting latent features from creative assets, placement metadata, and external signals to enrich the normalized dataset; and applying prescriptive and generative models to recommend or synthesize new assets. These operations are not routine or conventional, as they require specific data structures, algorithmic logic, and training artificial intelligence models, which would be understood to persons of ordinary skill in the art to be non-obvious computational operations that go beyond routine or generic computing and represent non-obvious improvements in the field of marketing analysis.

While a person may attempt to evaluate campaign performance mentally, some embodiments provide a scalable, automated, and data-driven mechanism that cannot be replicated by human thought. The normalization of heterogenous KPIs, aggregation of performance scores, and predictive modeling based on latent features are computationally intensive tasks that require specialized, trained machine learning models and algorithmic processing.

Some embodiments provide a dashboard visual representation of all (or a filtered set of) marketing assets at once, with a real-time overlay to provide quantitative and/or qualitative feedback of those assets' performance. The assets may include, but are not limited to, digital assets, non-digital assets, and first-party data. The overlay may be responsive to pre-defined performance criteria that are defined in a qualitative or quantitative manner on a per-asset basis.

For example, in some embodiments, the performance of created assets may be represented as a range of color varying from red to yellow to green. The color normalizes performance KPIs which are usually portrayed either by numbers or charts and graphs. This visual color overlay may help marketers understand what is or is not working.

Examples of non-digital marketing assets include, but are not limited to, brand logos, linear television, out-of-home advertising, print, radio, experiential, and retail store assets. In some embodiments, such assets may be manually uploaded to the system, and may be categorized using metadata, some of which may be auto-generated using various AI models. The performance criteria for such assets may be, but are not limited to, qualitative criteria.

Examples of digital marketing assets include, but are not limited to, connected TV, digital displays, social media websites (both paid and organic posts), influencers, search, e-commerce, and websites. In some embodiments, such assets may be entered into the system using an application programming interface (API) where available and may be categorized with metadata. The performance criteria for such assets may be, but are not limited to, quantitative criteria.

Examples of first-party data include, but are not limited to, digital collateral, physical collateral, email, SMS, shopping cart data, and purchase data. In some embodiments, such assets may be entered into the system using an application programming interface (API) where available and may be categorized with metadata. Performance criteria for such assets may be, but are not limited to, quantitative criteria.

As a non-limiting example, the assets may be displayed in a grid, and the overlay on each asset may be shades of red, yellow, or green filters, that indicate visually whether the asset's performance is meeting pre-defined criteria, failing to meet those criteria, or in a marginal condition. As another example, the overlay on each asset may be a heat map, where the intensity of the overlay is proportional to the pre-defined criteria.

In some embodiments, the system may memorialize historical marketing data and utilize AI to learn and adapt, making marketing an evolutionary process rather than a revolutionary one.

Advantages of the proposed solution include facilitating faster decision-making on creative direction and messaging strategies.

Some embodiments enable a marketer to integrate all their marketing creative assets, including digital assets and non-digital assets, in one unified view. This allows a marketing team to see the assets holistically and visualize the entire brand. Further, some embodiments may enable a marketing team to create a Vision Language Model (VLM).

Some embodiments integrate APIs to leading digital technology platforms, DSPs, social media platforms and other analytics tools to access performance data (using metrics and criteria that are referred to as Key Performance Indicators, or KPIs) for each vertical media marketing channel where a client runs advertising and marketing. Such embodiments provide an easy view of performance by translating what has historically been numbers and percentages in an excel sheet and converting it to an intuitive display, such as a red, yellow, and green overlay, a heatmap, or other type of filter. This gives marketing the visual cue to know if something is or isn't working.

Some embodiments go beyond data collection to actively curate and analyze performance data while constructing an extensive historical record. This data may then be intelligently processed by AI algorithms to construct dynamic integrated marketing models that illustrate every touchpoint in a customer journey. Ultimately this data may be used to develop dynamic models based upon broad AI analysis of creative assets and their performance in a specific marketing channel, effectively providing an ever-evolving architectural blueprint for the brand that gives marketing teams the insights and information they need to evolve their marketing and advertising. Marketers of all scales and budgets can optimize their strategies with evolutionary precision and insight.

In the marketing industry, and particularly in retail, marketers use the same channels and have different measures of success for each of those channels.

Some embodiments use color to normalize key performance indicators (KPIs) across multiple marketing segments. For example, different companies selling the same products may use the same marketing channels, but what they deem as success is different in each of those channels. The channels may include Social Media Company 1, Social Media Company 2, Social Media Company 3, programmatic advertising channels, linear advertising channels, out of home, print, catalogs, etc. Each company has a metric for success for their marketing channels. The ultimate measure of success is sales and revenue. But in managing each of the individual channels, there is no common baseline for marketing.

As an example, one company might use a 5% click through rate as a metric for success on a paid Social Media Company 1 campaign, while another company may use a two dollar cost per acquisition, and still another company may use a 3% click through rate. Each of these KPIs is essentially their designation of success.

As another example, for a particular platform and a particular KPI of using Click Through Rate (CTR) on Social Media Company 1 Ads-Customer 1 might consider 3% as success whereas customer 2 considers 3% as a failure and based on their domain, a 10% CTR is a success.

Even for a scenario with a single customer, a single platform, and a single KPI, there may be a difference in how success is measured. Campaigns running in New York City may expect a CTR of 3% but for the campaigns running in San Francisco, may expect a CTR of 8%. Alternatively, for that customer, for Social Media Company 1 ads, the customer may want to measure CTR for the New York campaign but for San Francisco, they may consider cost-per-click (CPC) to be more important. Accordingly, each customer may require different KPIs for different demographics.

In addition, the customer may have a multi-channel campaign, with different KPIs per channel. As an example, for the same customer, for Social Media Company 1 ads, they may consider click-through-rate (CTR) to be important, for Social Media Company 2 they may consider number of clicks, for a landing page on their website they may consider total number of impressions, and for an offline print ad, the total circulation may be considered important.

In some embodiments, to answer the question—“what is working and what is not”—success is measured across multiple dimensions simultaneously, including but not limited to customer, channel, campaign, demography (age, gender, location, etc.), and KPI.

Therefore, normalizing that data from a numbers' perspective may not be meaningful. Instead, some embodiments assign a color based on ranges of success. By assigning a color variable to success or failure, pools of data are created that are based on color that then allow the data to be normalized across different marketing segments.

The colors red and green may be used simply to denote whether something is moving in a positive or negative direction. Some embodiments go further by overlaying color on top of a creative asset based on performance indicators that are set by marketers and by channel to create an apples-to-apples comparison of the piece of creative asset and how that creative asset performs against marketing segments, defined by geography, demography, and other marketing audience variables.

For example, some embodiments apply a color to a KPI designation of success and then factoring percentages above or below what is deemed successful to define the depth of the color. The more successful, the more green, and the less successful, the more red, with neutral being represented as yellow. Some embodiments use the color visualization data to establish a training model for marketing and segments of marketing whereby data sources are combined, ranging from gender, to age, to income, to location, and more, to predict the success in those particular markets based on the success of historical marketing.

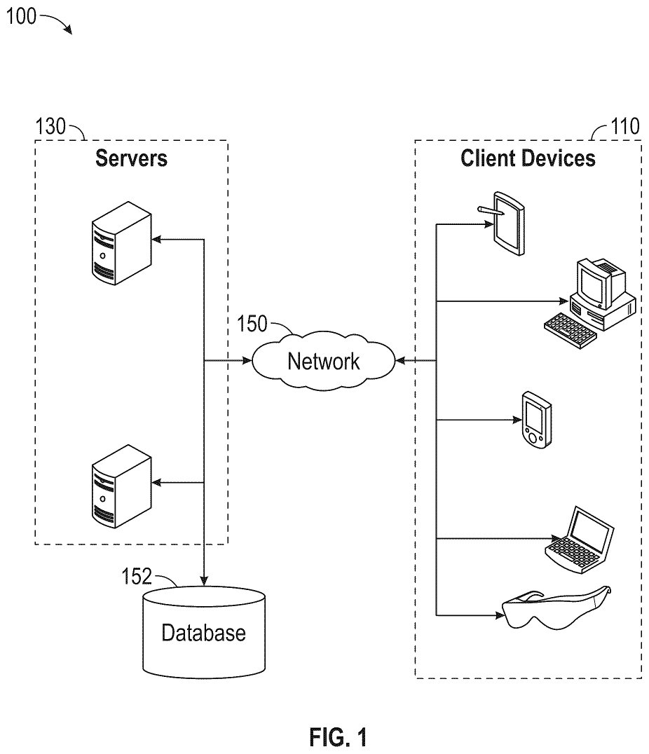

FIG. 1 illustrates a network architecture 100 for performance visualization, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

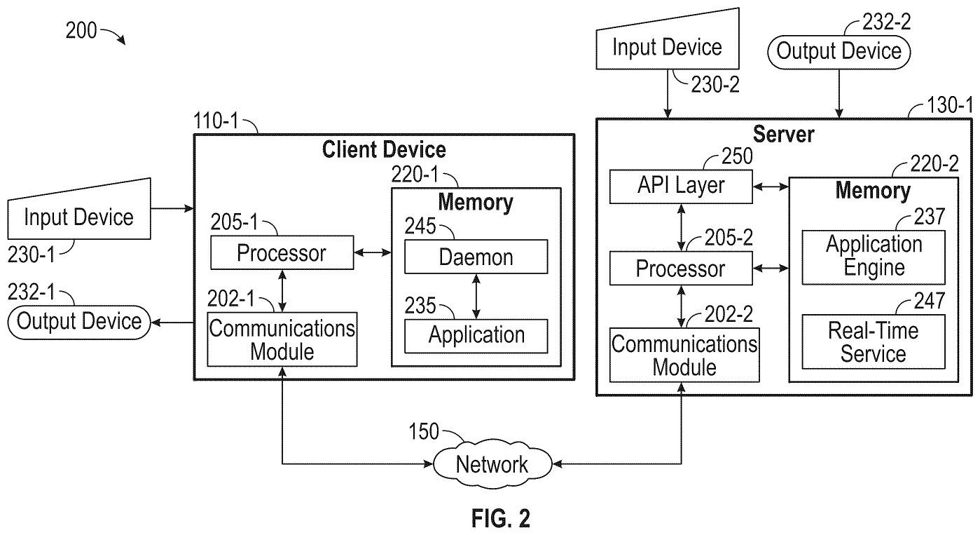

FIG. 2 is a block diagram illustrating details of a system 200 for performance visualization, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 235, configured to execute on client device 110-1 and couple with input device 230-1 and output device 232-1. The application 235 may be downloaded by the user from server 130-1, and/or may be hosted by server 130-1. The application 235 may include specific instructions which, when executed by processor 205-1, cause operations to be performed consistent with embodiments of the present disclosure. In some embodiments, the application 235 runs on an operating system (OS) installed in client device 110-1. In some embodiments, application 235 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 237. The application engine 237 may be configured to perform methods and operations consistent with embodiments of the present disclosure. The application engine 237 may share or provide features and resources with the client device 110-1, including data, libraries, and/or applications retrieved with application engine 237 (e.g., application 235). The user may access the application engine 237 through the application 235. The application 235 may be installed in client device 110-1 by the application engine 237 and/or may execute scripts, routines, programs, applications, and the like provided by the application engine 237.

Memory 220-1 may further include a daemon 245, configured to execute in client device 110-1. The daemon 245 may communicate with a real-time service 247 in memory 220-2 to provide real-time data to application 235. In some embodiments, application 235 and/or daemon 245 may communicate with application engine 237 and/or real-time service 247 through API layer 250.

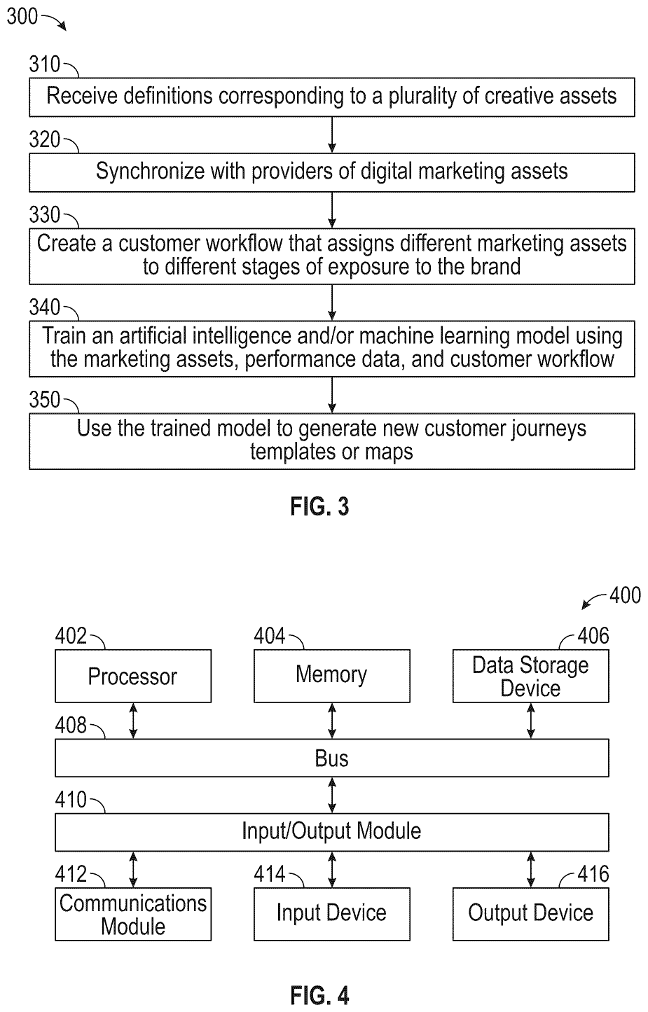

FIG. 3 is a flowchart illustrating a process 300 for performance visualization performed by a client device (e.g., client device 110, etc.) and/or a client server (e.g., server 130, etc.), according to some embodiments. In some embodiments, one or more operations in process 300 may be performed by a processor circuit (e.g., processors 205, etc.) executing instructions stored in a memory circuit (e.g., memories 220, etc.) of a system (e.g., system 200, etc.) as disclosed herein. For example, operations in process 300 may be performed by application 235, daemon 245, application engine 237, real-time service 247, or some combination thereof. Moreover, in some embodiments, a process consistent with this disclosure may include at least operations in process 300 performed in a different order, simultaneously, quasi-simultaneously, or overlapping in time.

At 310, the process 300 includes receiving definitions corresponding to a plurality of creative assets for marketing. For example, in some embodiments, a marketer uploads definitions for all their creative assets that cannot be accessed through an API. These assets include linear TV, videos, print, out of home, and other collateral like presentations, sell sheets, and brochures. The marketer may manage and add metadata such as who created the assets, when the asset is in market, and how the asset's success is measured, etc. In some embodiments, the marketer may assign a score (e.g., from 1-10, from 0-1, etc.) to the asset for qualitative measurement. They can also upload any research documents as backup to the core asset.

At 320, the process 300 includes synchronizing with providers of digital marketing assets. For example, in some embodiments, the marketer clicks on a link for the platforms they use for delivery of digital assets from digital advertising platforms affiliated with social media, search engines, and the like. The marketer may input their account's user ID and password, and a token then created in the back end of the platform to allow the system to ingest the creative assets managed on those platforms and their associated performance indicators. In some embodiments, the client may assign a benchmark performance indicator for platforms that do not assign one.

In some embodiments, the entered data is processed to assign a taxonomy to ensure that the performance data is being read properly. For example, the assignment and ingestion of performance data may be used to color an asset a shade of red, yellow, or green. Red may indicate an underperforming asset, yellow for hitting benchmarks, and green for surpassing benchmarks, for example.

At 330, the process 300 includes creating a customer workflow (also referred to herein as a “journey,” an “integration,” or an “integration/journey”) that assigns different marketing assets to different stages of exposure to the brand. For example, in some embodiments, the marketer may select from an Integration/Journey Blueprint and assigns associated creative assets to the appropriate step of the customer integration/journey. As an example, a journey map could include OOH, TV, and Print as first exposure to the brand, the second exposure being paid and organic social assets, the third exposure being a website or social page, and the fourth exposure being downloading a PDF, watching a video, or signing up for an email. The fifth exposure may be receiving an email, and the sixth exposure being scheduling an appointment or showing up at a retail location. The seventh exposure may be making a purchase, and the eight exposure may be a follow-up email or recruitment for membership program, etc. At this stage, the foundation has been established that associates each creative asset in the portfolio with a specific step in the customer integration/journey.

At 340, the process 300 trains an artificial intelligence and/or machine learning model using the marketing assets, performance data, and customer integration/journey. As an example, the system may use semantic search to learn by either looking back at historical data and assets or forward as marketing efforts evolve. This learning may be the foundation of creating marketing templates for brands that are evolutionary. With each new creative asset, the system may learn what works and doesn't work to inform the entire marketing ecosystem.

In some embodiments, the process 300 may maintain a Visual Memory, a structured representation of prior creative assets and their associated performance outcomes, which allows the model to recall, compare, and adapt insights from past campaigns when evaluating new assets.

At 350, the system uses the trained model to generate new customer journey templates. In some embodiments, the system also generates recommendations for creative asset executions that perform best at each step of the journey.

FIG. 4 is a block diagram illustrating an exemplary computer system 400 with which aspects of the subject technology can be implemented. In certain aspects, the computer system 400 may be implemented using hardware or a combination of software and hardware, either in a dedicated server, integrated into another entity, or distributed across multiple entities. As a non-limiting example, the computer system 400 may be one or more of the servers 130 and/or the client devices 110.

Computer system 400 includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry. As an example, special purpose logic circuitry may at least partially include a Graphics Processing Unit (GPU) configured for general-purpose parallel computation, including but not limited to machine learning and data processing tasks.

The instructions may be stored in the memory 404 and implemented in one or more computer program products, i.e., one or more modules of computer program instructions encoded on a computer-readable medium for execution by, or to control the operation of, the computer system 400, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in various computer languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Exemplary input/output modules 410 include data ports such as USB ports. The input/output module 410 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 416 include display devices such as an LCD (liquid crystal display) monitor, for displaying information to the user.

According to one aspect of the present disclosure, the above-described systems can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in the main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 400 reads application data and provides an application, information may be read from the application data and stored in a memory device, such as the memory 404. Additionally, data from the memory 404 servers accessed via a network, the bus 408, or the data storage 406 may be read and loaded into the memory 404. Although data is described as being found in the memory 404, it will be understood that data does not have to be stored in the memory 404 and may be stored in other memory accessible to the processor 402 or distributed among several media, such as the data storage 406.

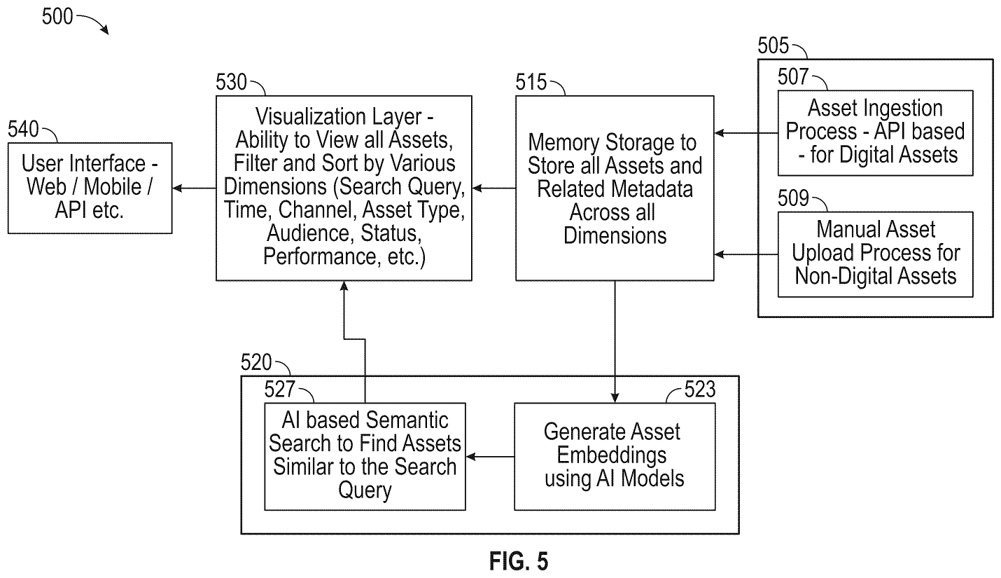

FIG. 5 illustrates a system 500 for creative asset management, according to some embodiments. The system 500 illustrates an example of how creative assets may be ingested, stored, processed, and visualized.

As shown, creative assets may be ingested into the system 500 through an asset ingestion component 505, which may include an API-based ingestion pipeline 507 for digital creative assets and a manual upload module 509 for non-digital creative assets. Once ingested, the creative assets and their associated metadata may be stored in memory storage 515 that is structured to retain information across multiple dimensions, including but not limited to time, channel, creative asset type, audience, performance, and status.

The stored creative assets may be processed by machine learning components 520. In some embodiments, a machine learning process 523 may be used to generate embeddings from the creative assets, that capture their latent and semantic features. These embeddings may further be leveraged by an AI-based semantic search engine 527 that allows users to locate and compare creative assets based on similarity to a search query or other criteria.

The results of these operations may be surfaced through a visualization layer 530, which allows users to view, filter, and sort creative assets across various dimensions such as search query, time, channel, asset type, audience, status, or performance. The visualization layer may be accessed through a user interface 540, which may include web-based portals, mobile applications, or APIs that enable integration with third-party platforms.

Taken together, the components of system 500 illustrate how some embodiments provide an integrated creative asset management framework that combines ingestion, structured storage, AI-based enrichment, and interactive visualization. This framework enables efficient retrieval, comparison, and strategic use of creative assets across multiple campaigns and channels.

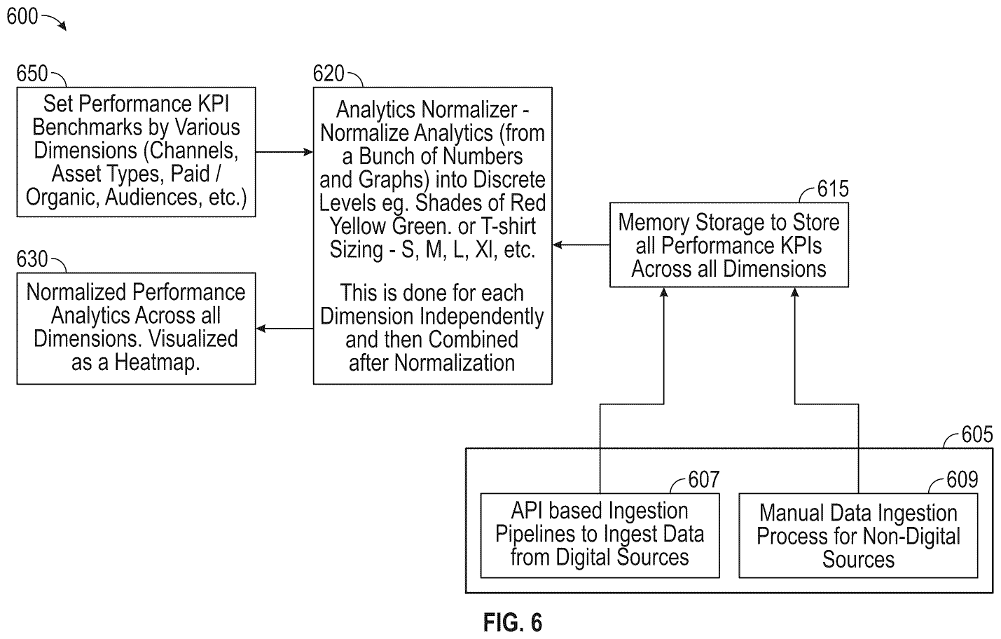

FIG. 6 illustrates a system 600 illustrating performance analytics and visualization, according to some embodiments. The system 600 illustrates an example of how disparate performance data may be ingested, normalized, and presented in a standardized format for cross-dimensional benchmarking and analysis.

As shown, creative assets may be ingested into the system 600 through an asset ingestion component 605, which may include an API-based ingestion pipeline 607 for digital creative assets and a manual upload module 609 for non-digital creative assets. Once ingested, memory storage 615 may store key performance indicator (KPI) information across multiple dimensions, including but not limited to time, channel, creative asset type, audience, performance, and status.

Once stored, the data may be processed by an analytics normalizer 620. In some embodiments, the analytics normalizer 620 may transform heterogeneous performance data into discrete standardized levels. For example, large ranges of raw performance values may be converted into normalized categories such as color-coded scales (e.g., shades of red, yellow, and green) or symbolic scales (e.g., T-shirt sizing such as S, M, L, and XL). Normalization may be performed for each dimension independently and then combined to provide an overall standardized representation of asset performance.

The system 600 may also include a performance visualizer component 630, which expresses the results of normalization as normalized performance analytics across all dimensions. These results may also be processed by the visualizer component 630 to display as a heatmap, that provides users with an intuitive view of relative performance, enabling comparisons across heterogeneous KPIs, channels, and asset types that would otherwise be difficult to evaluate in a consistent manner.

The system 600 may also include a benchmarking component 650 that allows users or the system to set performance KPI benchmarks across multiple dimensions. These dimensions may include, but are not limited to, marketing channels (e.g., digital, non-digital, paid social, organic), asset types (e.g., video, static image, carousel, print), audience characteristics (e.g., demographics, interests, geography), and campaign classifications (e.g., paid versus organic). The benchmarking component 650 defines the thresholds or reference points against which subsequent performance data may be normalized by the analytics normalizer 620. By establishing these standardized benchmarks, the system ensures that heterogeneous KPIs can be evaluated consistently, enabling meaningful cross-dimensional comparison in later stages of processing.

Taken together, the components of system 600 illustrate how some embodiments provide a technical framework for ingesting, storing, normalizing, and visualizing performance analytics. By creating standardized, machine-readable performance scales and rendering them as heatmaps, the system enables automated benchmarking and decision-making across multiple marketing dimensions.

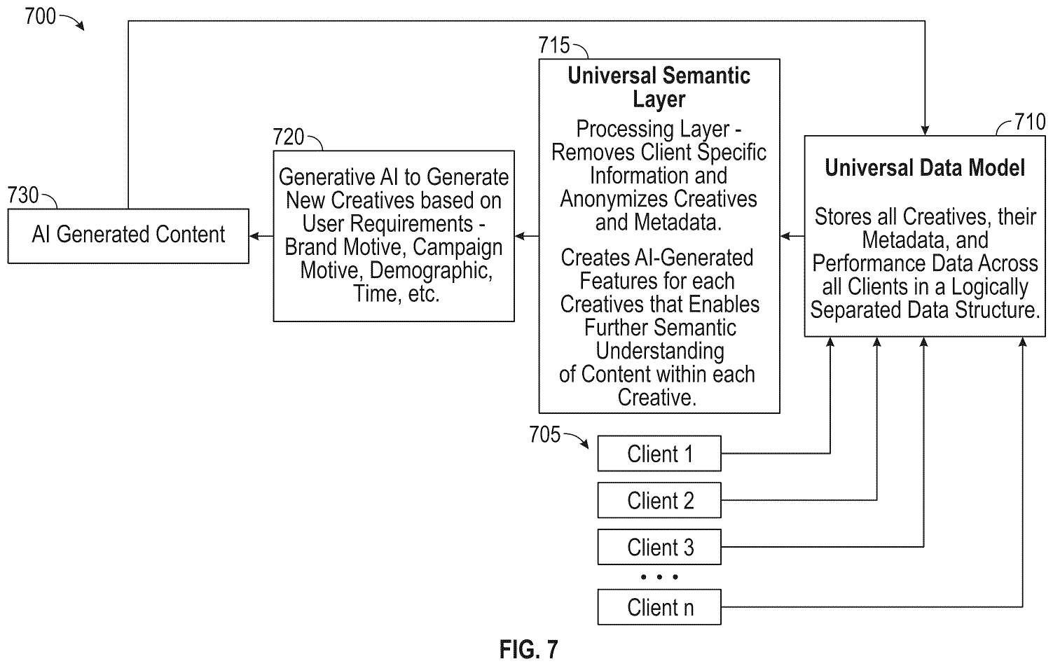

FIG. 7 illustrates a system 700 for using generative artificial intelligence to generate creative assets, according to some embodiments. The diagram depicts a processing flow that aggregates data from multiple clients, semantically processes and anonymizes that data, and then conditions a generative model to produce new creative outputs.

Initially, multiple clients 705 (Client 1, Client 2, Client 3, . . . , Client n) provide creatives, associated metadata, and performance records to a universal data model 710. The universal data model 710 stores all creatives, their metadata, and performance data across all clients 705 in a logically separated data structure (for example, tenant partitions, namespaces, or access-controlled tables) so that each client's content remains isolated while still enabling cross-client learning where permitted.

A universal semantic layer 715 of system 700 may operate on data retrieved from the universal data model 710. The universal semantic layer 715 may remove client-specific identifiers, anonymize creatives and metadata, normalize taxonomies, and generate AI-based semantic features for each creative (e.g., embeddings or latent vectors). The resulting features provide a consistent representation of content that is independent of the originating client and suitable for downstream modeling.

A generative AI module 720 of system 700 may be conditioned using the semantic features from the universal semantic layer 715, based on user requirements including but not limited to as brand motive, campaign motive, demographic parameters, and temporal context. As outputs, the generative AI module 720 generates creative assets 730. In some embodiments, generated assets are returned to the requesting client and/or written back to the universal data model 710 together with their metadata, semantic features, and lineage information, thereby closing the loop for subsequent benchmarking, reuse, and model retraining.

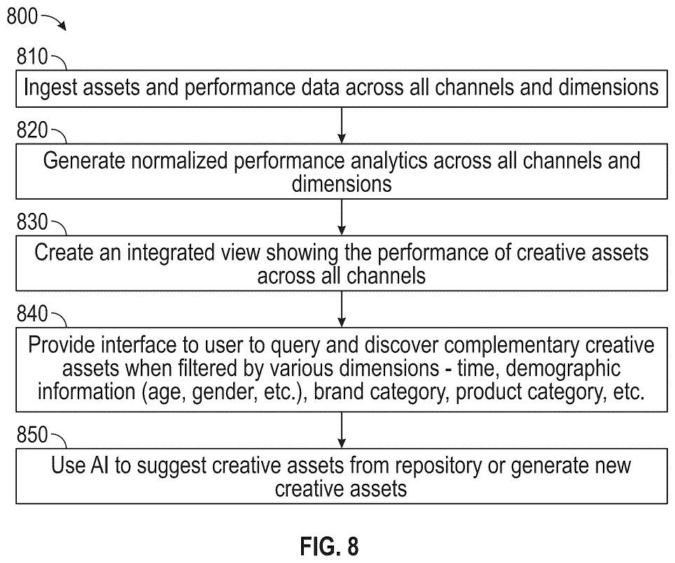

FIG. 8 is a flowchart illustrating a process 800 for performance visualization performed by a client device (e.g., client device 110, etc.) and/or a client server (e.g., server 130, etc.), according to some embodiments. In some embodiments, one or more operations in process 800 may be performed by a processor circuit (e.g., processors 205, etc.) executing instructions stored in a memory circuit (e.g., memories 220, etc.) of a system (e.g., system 200, etc.) as disclosed herein. For example, operations in process 800 may be performed by application 235, daemon 245, application engine 237, real-time service 247, or some combination thereof. Moreover, in some embodiments, a process consistent with this disclosure may include at least operations in process 800 performed in a different order, simultaneously, quasi-simultaneously, or overlapping in time.

At 810, the process 800 ingests assets and performance data across all channels and dimensions. As described above with reference to FIG. 5 and FIG. 6, assets may be ingested via API pipelines or manual upload and stored together with metadata such as format, dimensions, audience information, and associated campaign KPIs. Performance data may be ingested from disparate sources, including digital platforms, non-digital channels, and data-producing systems.

At 820, the process 800 generates normalized performance analytics across all channels and dimensions. As described above with respect to FIG. 6, raw KPIs such as impressions, conversions, and engagement values may be transformed into normalized scores using benchmarking thresholds and aggregation logic. This operation ensures that otherwise incomparable performance metrics are converted into consistent indicators that can be objectively compared across creative asset types, delivery channels, and audience segments.

At 830, the process 800 creates an integrated view showing the performance of creative assets across all channels. In some embodiments, the integrated view is presented as a heatmap, with each creative asset represented by a color corresponding to its normalized performance tier. This integrated visualization allows users to understand, at a glance, which creative assets are performing strongly and which are underperforming across the full marketing ecosystem.

At 840, the process 800 provides an interface to a user to query and discover complementary creative assets when filtered by various dimensions-time, demographic information (age, gender, etc.), brand category, product category, etc. As described above with reference to FIG. 6, the system may allow filtering by various criteria, including but not limited to time windows, demographic attributes, and campaign classifications such as brand category or product category. The query interface may also support semantic search of assets, as illustrated in FIG. 5.

At 850, the process 800 uses a trained AI model to suggest creative assets from a repository or generate new creative assets. As discussed in FIG. 7, the system may employ AI models that have been trained on historical asset performance and metadata. In some embodiments, the AI may recommend existing assets from the repository that are predicted to perform well in a given context, and/or synthesize new creative variations conditioned on campaign objectives, demographic targeting, or brand requirements.

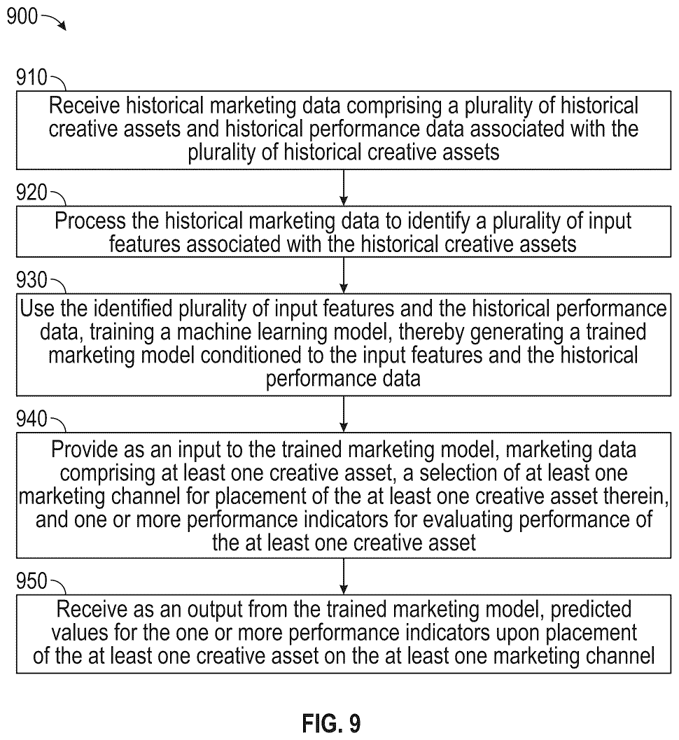

FIG. 9 is a flowchart illustrating a process 900 for optimizing performance of creative assets, performed by a client device (e.g., client device 110, etc.) and/or a client server (e.g., server 130, etc.), according to some embodiments. In some embodiments, one or more operations in process 900 may be performed by a processor circuit (e.g., processors 205, etc.) executing instructions stored in a memory circuit (e.g., memories 220, etc.) of a system (e.g., system 200, etc.) as disclosed herein. For example, operations in process 900 may be performed by application 235, daemon 245, application engine 237, real-time service 247, or some combination thereof. Moreover, in some embodiments, a process consistent with this disclosure may include at least operations in process 900 performed in a different order, simultaneously, quasi-simultaneously, or overlapping in time.

At 910, the process 900 receives historical marketing data comprising historical creative assets and historical performance data associated with the historical creative assets. The historical performance data may include performance measurements for historical performance indicators associated with the historical creative assets.

At 920, the process 900 processes the historical marketing data to identify input features associated with the historical creative assets.

In some embodiments, the identified input features comprise at least one of creative features, placement features, external features, or any combination thereof. The creative features may include, but are not limited to, attributes of the creative asset, format of the creative asset, metadata of the creative asset, design elements of the creative asset, content of the creative asset, or any combination thereof. The placement features may include, but are not limited to, marketing channel, content type, placement location, timing attributes, audience demographics, campaign objectives, or any combination thereof.

At 930, the process 900 uses the identified input features and the historical performance data to train a machine learning model, thereby generating a trained marketing model conditioned to the input features and the historical performance data.

In some embodiments, the process 900 further identifies external features associated with the historical creative assets and further uses the identified external features to train the machine learning model, so that the trained marketing model is further conditioned to the external features. The external features may include, but are not limited to, environmental conditions, market conditions, weather data, news information, social trends, economic indicators, consumer sentiment, competitor activity, or any combination thereof.

In some embodiments, the process 900 further normalizes the performance measurements to a standardized range. The normalized performance measurements may also be used to train the machine learning model, so that the trained marketing model is further conditioned to the normalized performance measurements. In some embodiments, multiple thresholds may be defined, that are associated with the standardized range. As an example, the thresholds may be mapped to a range of color values.

At 940, the process 900 provides, as an input to the trained marketing model, marketing data comprising at least one creative asset, a selection of at least one marketing channel for placement of the at least one creative asset therein, and one or more performance indicators for evaluating performance of the at least one creative asset.

In some embodiments, the selection of at least one marketing channel is from marketing channels including, but not limited to, digital channels, non-digital channels, data-producing channels, or any combination thereof.

In some embodiments, the process 900 further provides, as another input to the trained marketing model, target values for the one or more performance indicators.

At 950, the process 900 receives, as an output from the trained marketing model, predicted values for the one or more performance indicators upon placement of the at least one creative asset on the at least one marketing channel.

In some embodiments, the process 900 further receives, as another output from the trained marketing model, a recommendation from a repository of available creative assets of one or more predefined creative assets that are predicted to achieve the target values of the one or more performance indicators upon placement of the one or more predefined creative assets on the at least one marketing channel.

In some embodiments, the process 900 further receives, as another output from the trained marketing model, a recommendation of a marketing channel for placement of the at least one creative asset to achieve the target values of the one or more performance indicators.

In some embodiments, the process 900 further receives, as another output from the trained marketing model, a recommendation of advertising campaign parameters, the advertising campaign parameters comprising at least one of timing parameters, audience parameters, budget parameters, or any combination thereof, wherein the advertising campaign parameters are predicted to achieve the target values of the one or more performance indicators during placement of the at least one creative asset on the at least one marketing channel.

In some embodiments, the process 900 further provides, as another input to the trained marketing model, target values for the one or more performance indicators, and generates, using the trained marketing model, at least one new creative asset that is predicted to achieve the target values of the one or more performance indicators upon placement of the at least one new creative asset on the at least one marketing channel.

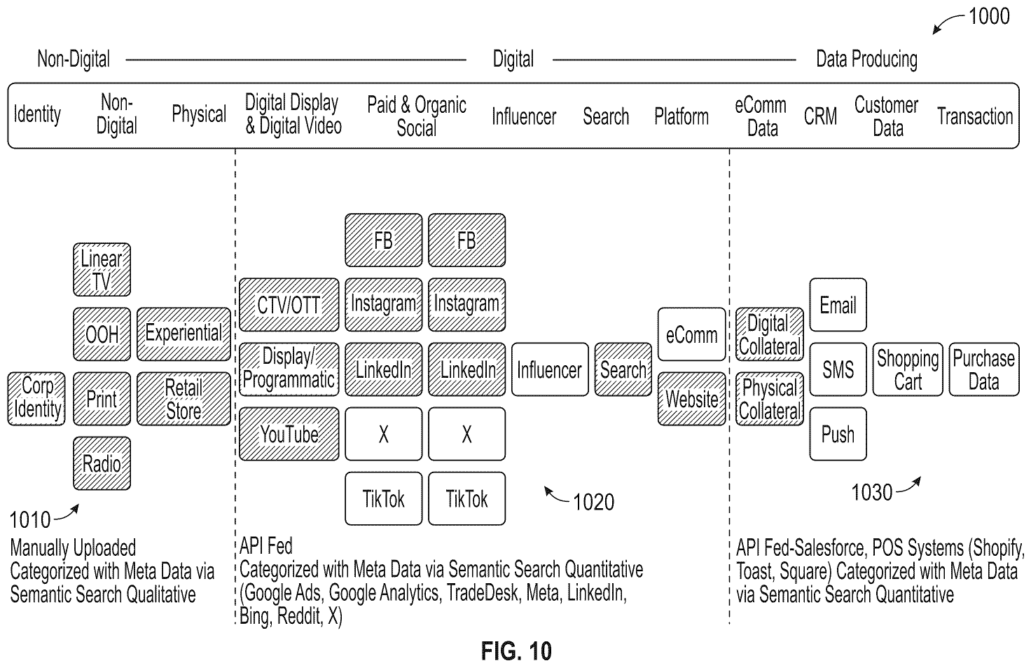

FIG. 10 is a diagram 1000 illustrating a categorization of marketing channels, according to some embodiments. In this example, the channels are organized into three domains: non-digital channels 1010, digital channels 1020, and data producing channels 1030. Each channel may be a marketing input that some embodiments may ingest, normalize, and analyze to generate insights into the performance of creative assets. Each channel may be shaded to indicate that it is presently active or not shaded to indicate that it is inactive.

The non-digital channels 1010 include, but are not limited to, traditional and physical marketing channels such as corporate identity, linear television (TV), out-of-home (OOH) advertising, print media, and radio. It also encompasses physical engagement environments like experiential marketing and retail stores. These channels typically produce qualitative data and may require manual upload and semantic categorization.

The digital channels 1020 are internet-based advertising and engagement platforms. These include, but are not limited to, digital display and video formats such as connected TV (CTV), over-the-top (OTT) streaming, display ads, programmatic media, and YouTube. Social media platforms are divided into paid and organic categories, including Facebook, Instagram, LinkedIn, and TikTok. Influencer marketing and search-based advertising are also represented. These digital channels may provide quantitative data via APIs and may be categorized using semantic search and metadata tagging.

The data producing channels 1030 are platforms and systems that generate first-party and transactional data. These include eCommerce platforms, websites, CRM systems (email, SMS, push notifications), shopping cart data, and purchase transaction records. These sources enable measuring downstream marketing impact and ROI. Data from these systems may be ingested via APIs from platforms such as Google Ads, Google Analytics, Meta (Facebook), LinkedIn, Bing, TradeDesk, Salesforce, Shopify, Toast, and Square, and may be categorized using semantic search and metadata tagging.

The example of FIG. 10 underscores the complexity and heterogeneity of the marketing ecosystem and highlights the utility of a unified system that can normalize, benchmark, and analyze performance across these varied inputs. It also illustrates the foundation for AI-driven modeling of some embodiments as described below, which relies on structured and semantically enriched data from these channels to generate predictive and prescriptive insights.

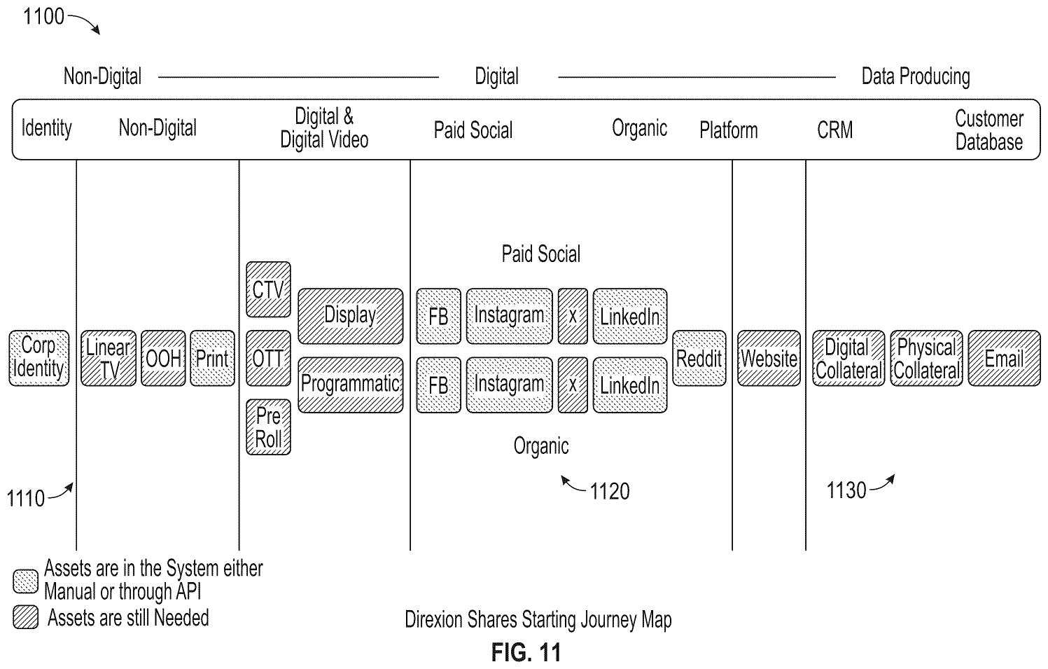

FIG. 11 is a diagram 1100 illustrating a categorization of marketing channels, according to some embodiments. The diagram 1100 is similar to the embodiment of the diagram 1000 described above with respect to FIG. 10, and like reference numbers have been used to refer to the same or similar components. A detailed description of some components has been omitted, and the following discussion focuses on the differences between these embodiments. Any of the various features discussed with any one of the embodiments discussed herein may also apply to and be used with any other embodiments.

The example of diagram 1100 uses a color-coding scheme to indicate the integration status of each creative asset type. Lightly-shaded cells represent creative assets that are already present in the system, either through manual upload or API-based ingestion. Darkly-shaded cells indicate gaps, where creative assets or data sources are still needed to complete the marketing journey map. This visual classification provides an immediate overview of where creative assets have been incorporated and where data gaps remain.

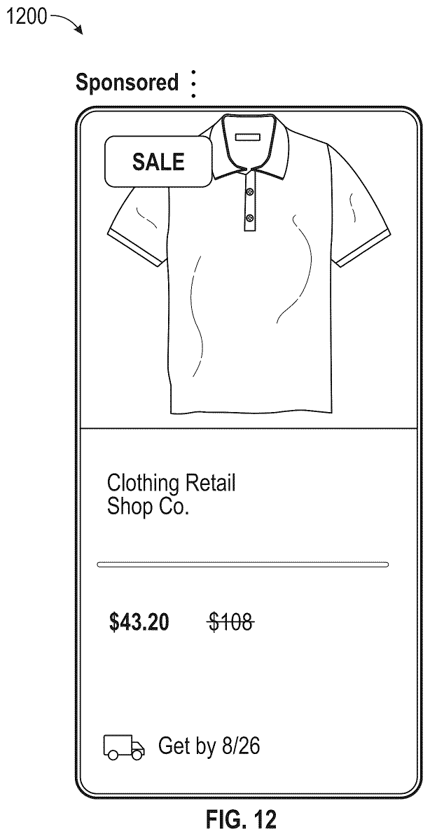

FIG. 12 illustrates an example advertisement asset 1200, according to some embodiments. In this example, the asset is a digital advertisement for a clothing retailer intended to be displayed on an e-commerce or shopping website. In this example, the campaign parameters may target customers who are male, aged 18-36, and located in New York City. Performance of the advertisement asset 1200 may be measured using a variety of key performance indicators (KPIs), such as click-through rate (CTR), cost-per-click (CPC), impressions, conversions, and total clicks. For instance, in this example, the advertisement asset 1200 may achieve a CTR of 5%, CPC of $0.05, and 10,000 clicks. These raw performance values represent heterogeneous metrics that cannot be directly compared across different channels or campaigns without normalization.

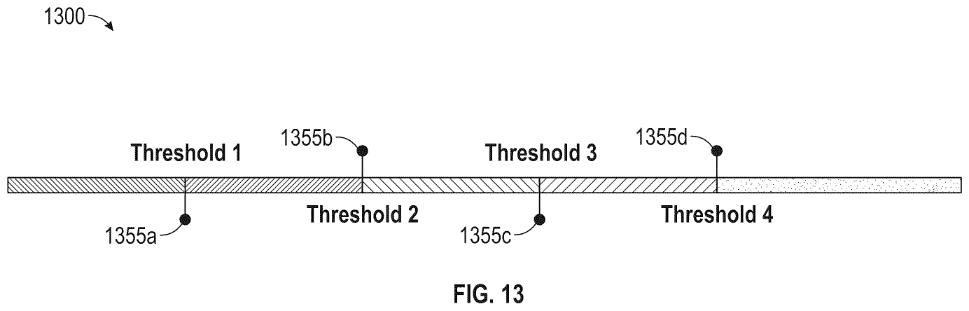

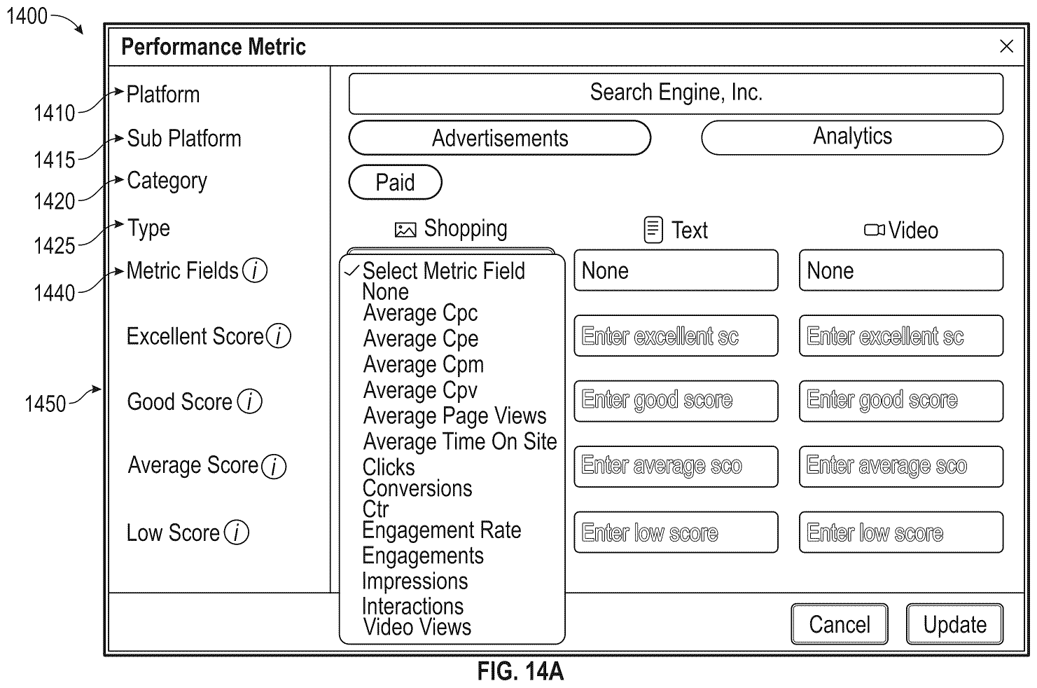

FIG. 13 illustrates a color scale 1300 used to normalize KPI performance into discrete ranges according to configurable thresholds 1355a, 1355b, 1355c, and 1355d, according to some embodiments. In this example, the clothing retailer defines CTR as the most important KPI for the advertisement asset 1200 of FIG. 12. The retailer may establish performance thresholds at 8%, 6%, 4%, and 2% CTR, with each threshold corresponding to a different segment of the color scale. For example, performance at or above 8% CTR may be mapped to a dark green band (indicating strong performance), while performance below 2% may be mapped to a dark red band (indicating poor performance), with intermediate ranges represented by lighter green, yellow, or orange tones.

Taken together, FIGS. 12 and 13 illustrate how raw KPI values for a given advertisement asset 1200 may be transformed into a normalized, color-coded representation of performance. Because the ad of FIG. 12 achieved a CTR of 5%, this value would fall between the second threshold 1355b (6%) and the third threshold 1355c (4%) on the color scale of FIG. 13. Accordingly, the performance of this advertisement asset 1200 would be visualized in the yellow range, indicating moderate performance relative to the user-defined benchmarks. This enables direct comparison of the advertisement asset 1200 against other creative assets, regardless of the underlying KPI units or reporting format.

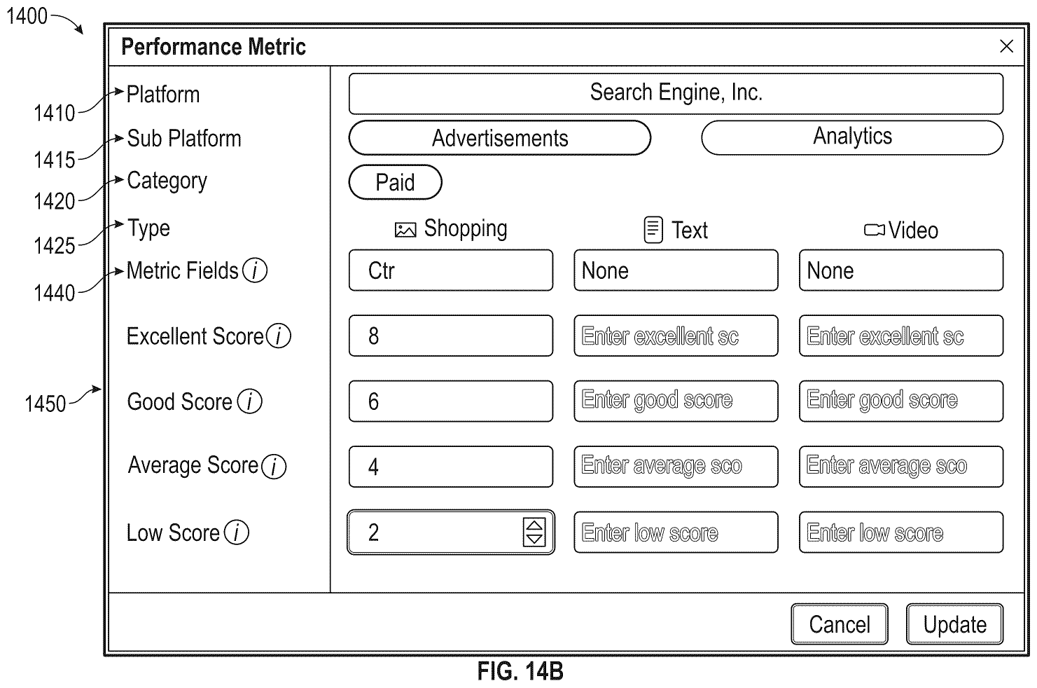

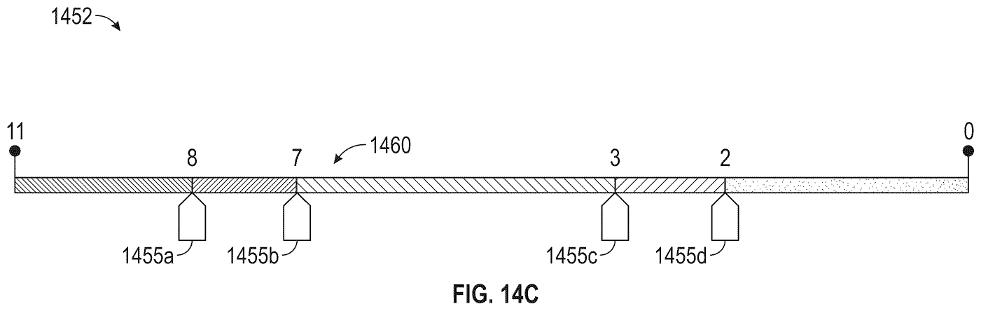

FIGS. 14A and 14B illustrate an example user interface 1400 for defining performance thresholds for key performance indicators (KPIs), according to some embodiments. KPI performance values (e.g., CTR, CPC, conversions) for an advertisement asset (e.g., advertisement asset 1200) may be normalized into a color-coded representation using configurable thresholds. In FIG. 14A, the user selects a KPI from a drop-down menu 1440, such as CTR, for a particular platform 1410, sub-platform 1415, category 1420, and type 1425. The user may then enter explicit numeric values in numeric fields 1450 for the thresholds that determine color assignments. In this example, consistent with the example of FIG. 13, the thresholds for CTR are set at 2%, 4%, 6%, and 8%. These thresholds define the boundaries between low-, medium-, and high-performance ranges, which are subsequently mapped to color gradations (e.g., red, yellow, green, etc.).

FIG. 14C illustrates an alternative user interface 1452 for defining thresholds, according to some embodiments. Instead of entering numeric values directly, the user manipulates slider markers 1455a, 1455b, 1455c, and 1455d along a color scale 1460 to set the thresholds visually. In this example, the system may determine (e.g., based on historical performance) a minimum and maximum range of observed CTR values for the client and channel, and the user can adjust the sliders to define the boundaries within that range. In this example, the user has modified the thresholds 1455a-1455d to be 8%, 7%, 3%, and 2%, respectively. The four thresholds divide the scale into five color-coded bands: two shades of green for strong performance, a yellow band for average performance, and two shades of red for weak performance.

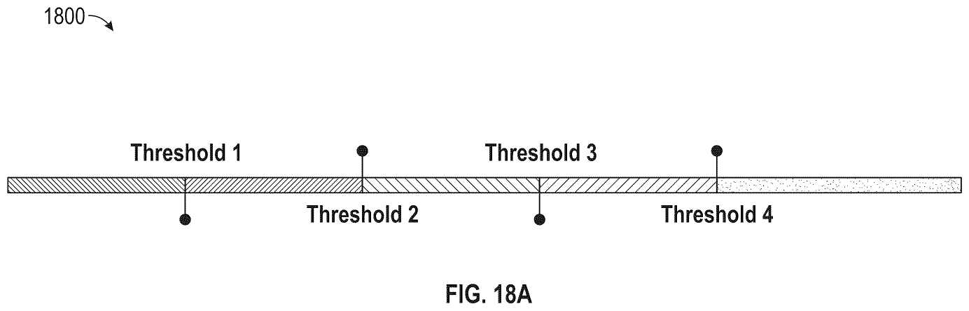

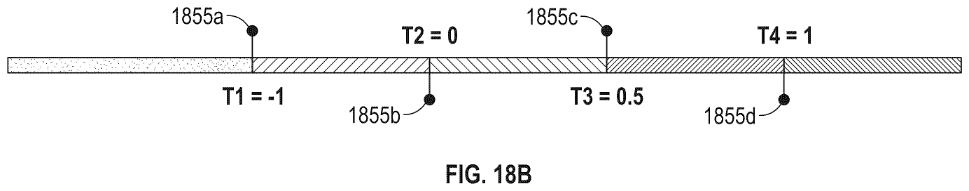

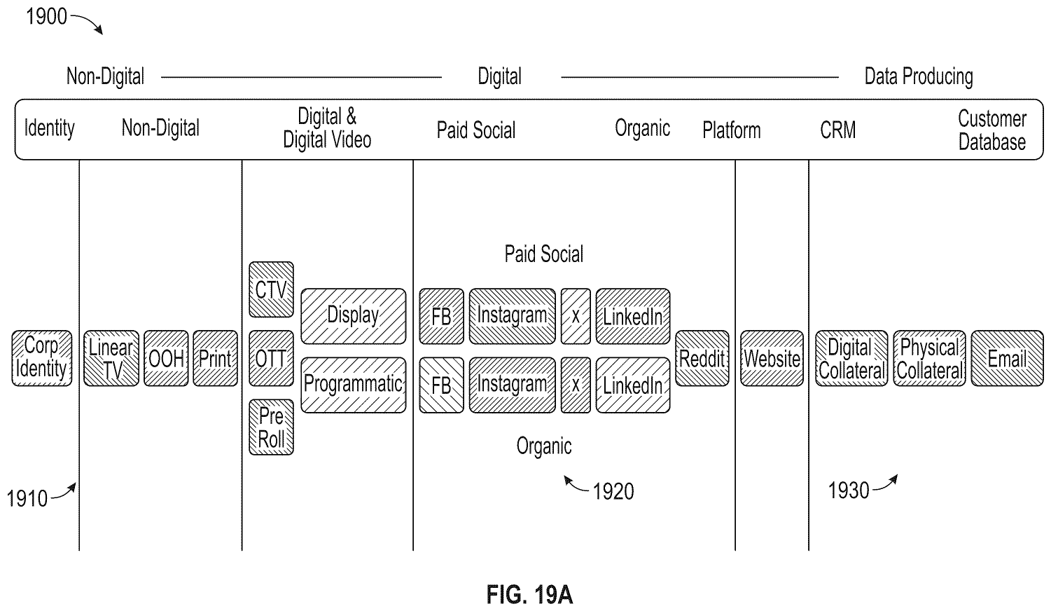

In the example of FIG. 14C, the threshold values are arranged horizontally from best value (dark green) on the left to the worst value (dark red) on the right, and the user-defined thresholds for color assignments manipulated by sliders along the color scale for each metric independently. Other arrangements, including but not limited to right-to-left (e.g., FIG. 18B below), vertically from top to bottom, and vertically from bottom to top, are also contemplated. Any desired number of thresholds may be defined and mapped to a corresponding number of color gradations.

In this example, there are two color ranges for green, one for yellow, and two for red, with darkest green indicating best performance and darkest red indicating worst performance. However, more than three colors may be used, and any number of dark/light gradations of each color may be used. As a non-limiting example, only two sliders may be used, defining only three gradations (green, yellow, and red). As another non-limiting example, five sliders may be used, defining six color gradations, two for green, two for yellow, and two for red.

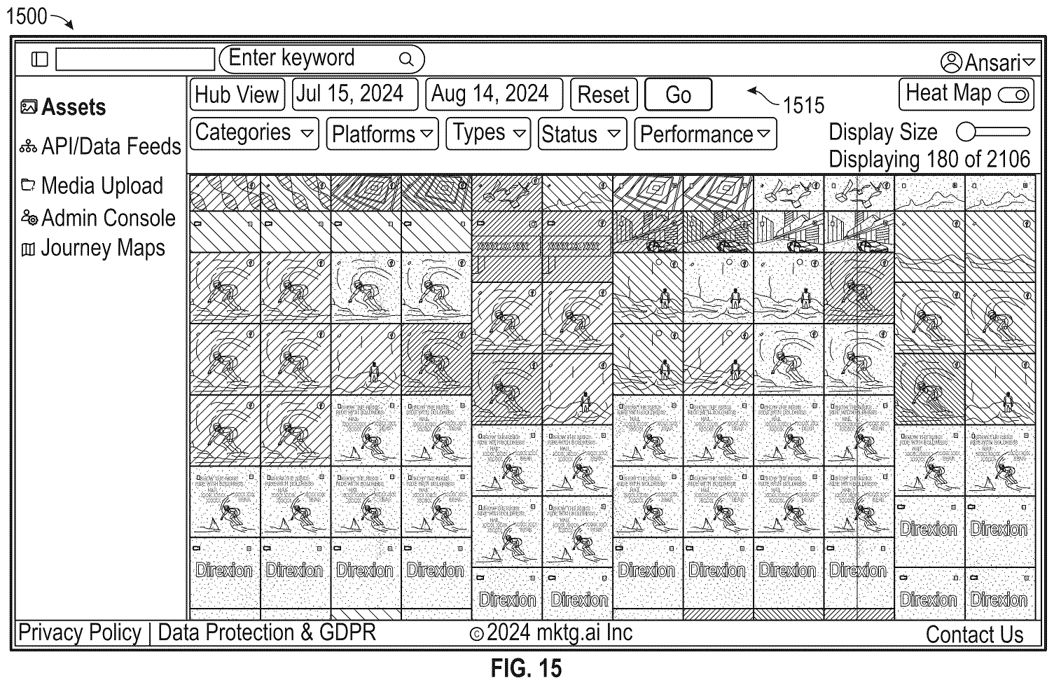

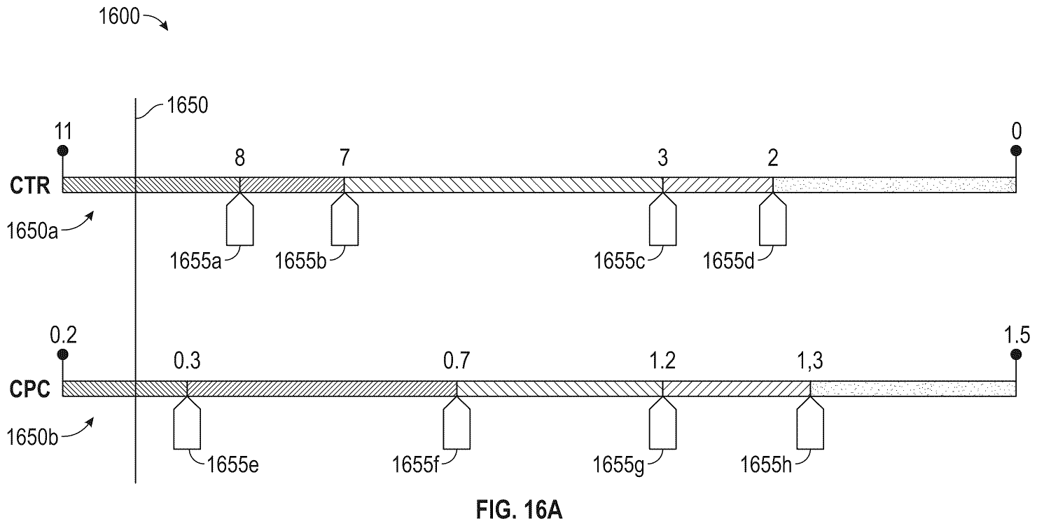

FIG. 15 illustrates an example of a color indicator 1500 for creative asset performance evaluation, according to some embodiments. In this example, the color indicator is presented as a heatmap, though other visualizations and/or filters are contemplated. The color indicator 1500 provides a visual representation of marketing asset performance across multiple dimensions, including category, platform, asset type, and campaign status, over a date range (e.g., Jul. 15, 2024 to Aug. 14, 2024), all selectable using filtering controls 1515. Each cell in the color indicator 1500 corresponds to a specific creative asset or campaign element and is color-coded based on its performance relative to predefined KPI thresholds. The cell displays an image, a label, or some other unique identifier of the specific asset, based on the asset type. The color scale of each cell ranges from red (indicating poor performance), through yellow (moderate performance), to green (strong performance), allowing users to quickly assess which assets are underperforming, meeting expectations, or excelling. Some embodiments algorithmically assign these colors by comparing actual performance metrics, including but not limited to CTR, CPC, impressions, and/or clicks, against client-specific benchmarks configured within the platform using an interface such as the interfaces of FIG. 14A-C, as described above.

The user interface for the color indicator 1500 includes filtering controls 1515 for narrowing the view by one or more of a category, a platform, a type, a status, a performance level, and other factors. The user interface may also support dynamic resizing and date range selection.

### Multiple KPIs

More than one KPI may be used to evaluate an asset. In some embodiments, the color assignment may reflect the lowest-performing metric to ensure conservative evaluation. Alternatively, the color assignment may reflect the highest-performing metric, an average, a weighted average, a specific metric according to a priority order, or any other combination or selection of the metrics used for evaluation of that asset.

As an example, a CTR of 8% itself may not be considered impressive unless there are at least 10,000 clicks on the creative asset. Moreover, that may not be useful unless the CPC is 10 cents or less. Accordingly, some combination of CPC, CTR and Clicks may be a combined metric that the user may desire to use as a measure of success.

Each KPI may be individually assessed. For example, if the CPC is too high, then it may be too expensive and there's not enough return on ad spend (ROAS). If there are not enough clicks, then the campaign may not be performing as expected. If the CTR is not enough, then there may not be enough clicks for the impressions that the asset is getting. Accordingly, more optimization may be needed.

In some embodiments, the user interface may be used to set up thresholds of multiple KPIs together and then define a custom metric accordingly.

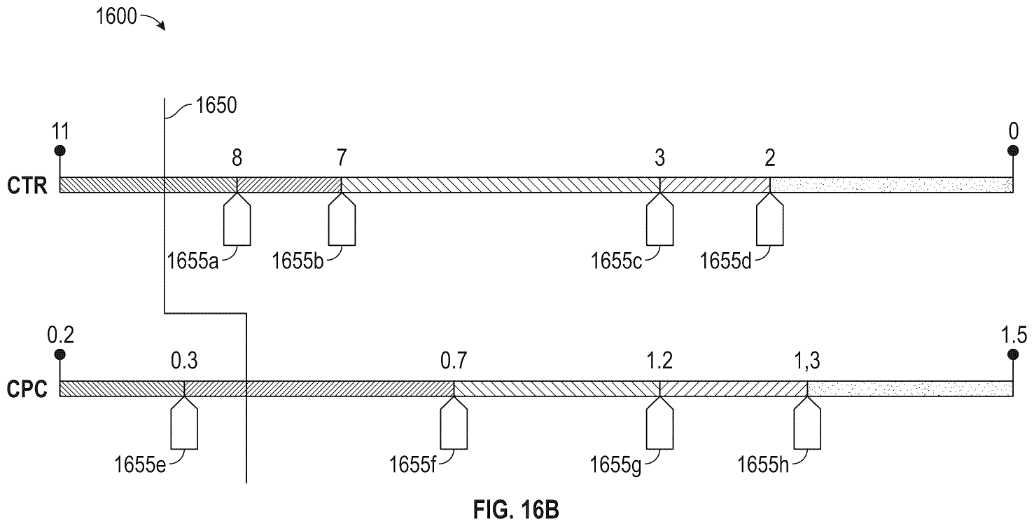

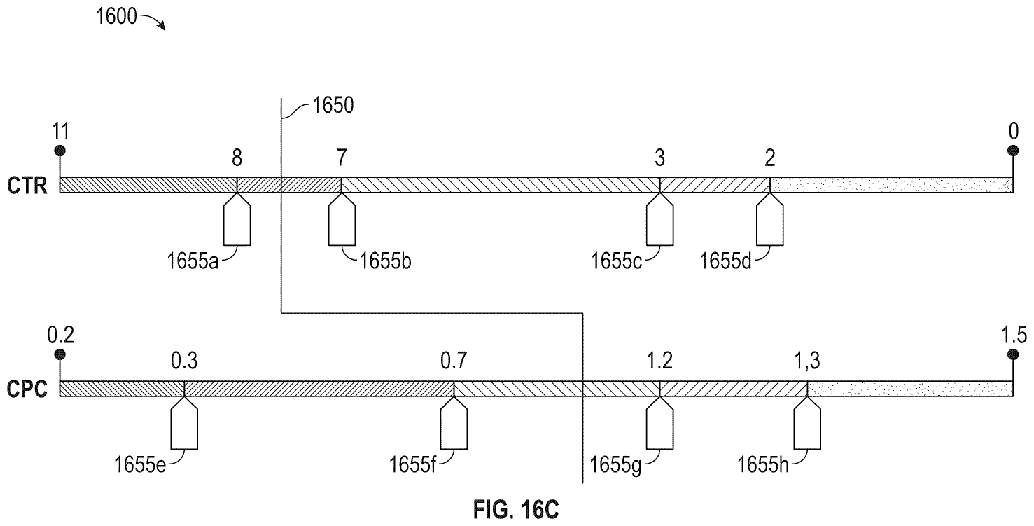

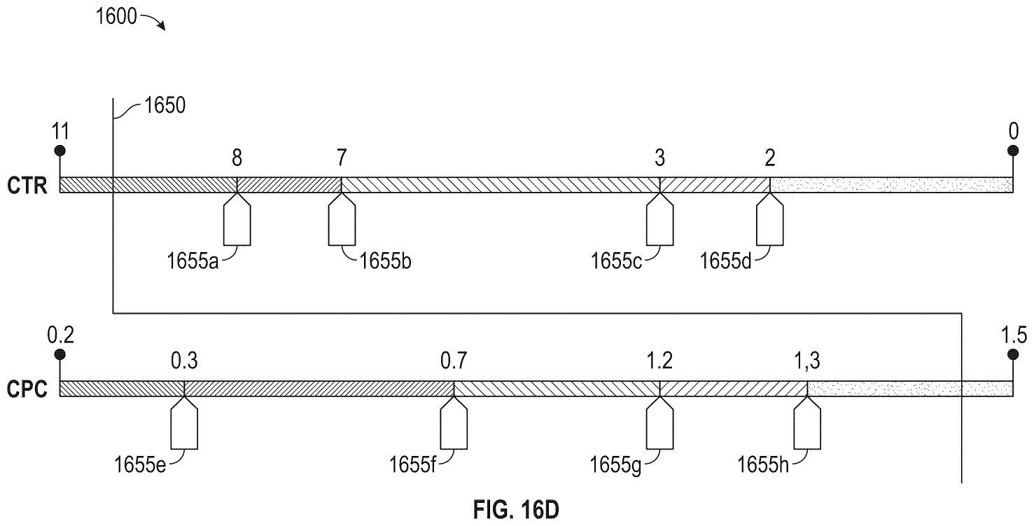

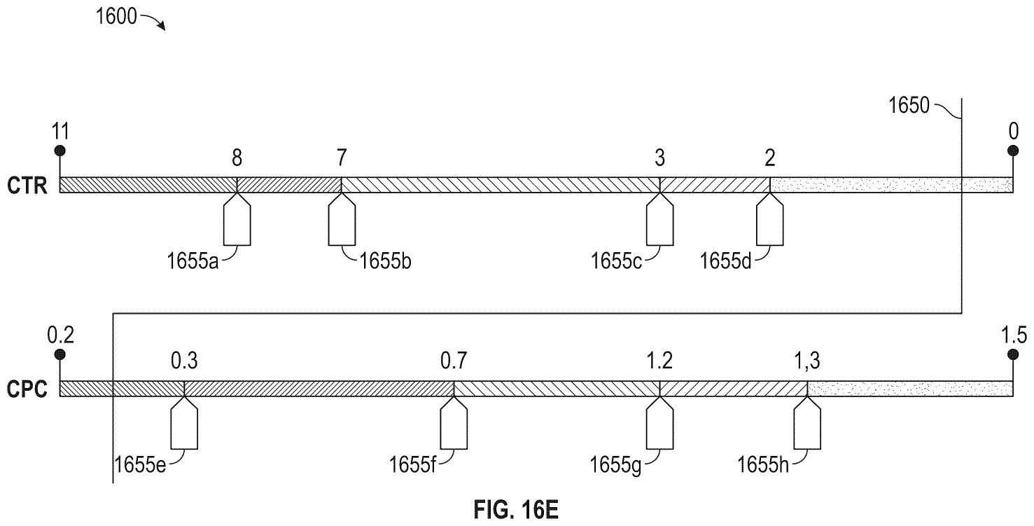

FIGS. 16A-16E show an example of a user interface 1600 for evaluating different scenarios of an asset's performance according to multiple KPIs, according to some embodiments. The user interface 1600 is similar to the embodiment of the user interface described above with respect to FIG. 14C, and like reference numbers have been used to refer to the same or similar components. A detailed description of some components has been omitted, and the following discussion focuses on the differences between these embodiments. Any of the various features discussed with any one of the embodiments discussed herein may also apply to and be used with any other embodiments.

In these examples, the two metrics being used are CTR (defined along top color scale 1650a) and CPC (defined along bottom color scale 1650b), and the vertical line 1650 explains where the asset stands in terms of CTR and CPC performance. This example has four sliders 1655a, 1655b, 1655c, and 1655d to adjust the thresholds for CTR and four sliders 1655e, 1655f, 1655g, and 1655h to adjust the thresholds for CPC. In these scenarios, the custom metric is defined as the worst outcome across all metrics, though other metrics may be contemplated, including but not limited to a best outcome, a weighted or an unweighted outcome, a prioritized outcome, and the like.

In FIG. 16A, the creative asset has excellent CTR and CPC, falling below the best threshold of both metrics. Accordingly, the creative asset is assigned a dark green shade on the color scale.

In FIG. 16B, although the CTR is in the dark green range, the CPC is in the light green range. Accordingly, the creative asset is assigned a light green shade on the color scale.

In FIG. 16C, the CTR is in the light green range, and the CPC is in the yellow range. Accordingly, the creative asset is assigned a yellow shade on the color scale.

In FIG. 16D, the CTR is in the dark green range (very good performance), but the CPC is in the dark red range (very poor performance). Accordingly, the creative asset is assigned a dark red shade on the color scale.

In FIG. 16E, the CPC is in the dark green range (very good performance), but the CTR is in the dark red range (very poor performance). Accordingly, the creative asset is assigned a dark red shade on the color scale.

Some embodiments provide a performance score to compare performance across platforms, placements, and campaigns, according to some embodiments. Capturing placement-level data enables a user to assess which creative assets may perform best in specific environments. Placement-specific data also feeds into heatmap generation (e.g., color indicator 1500, which is described above with reference to FIG. 15) and predictive modeling processes, allowing for more accurate benchmarking and strategic optimization.

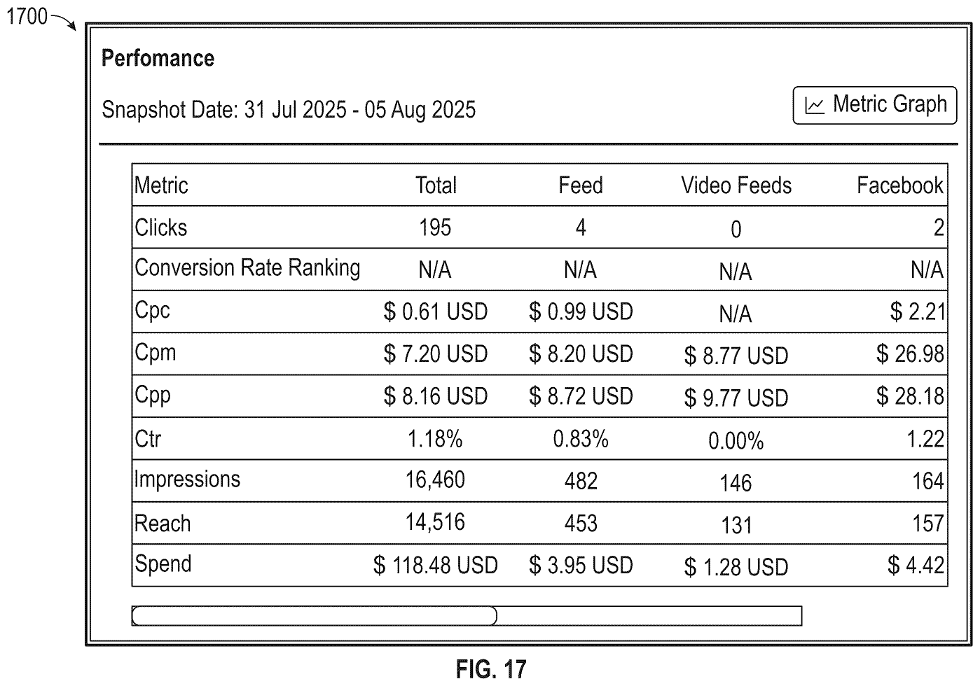

FIG. 17 illustrates a performance breakdown 1700 of marketing assets by placement, according to some embodiments. The figure presents a snapshot of campaign metrics collected between Jul. 31, 2025, and Aug. 5, 2025, and demonstrates how placement-level data may be captured and organized for a particular creative asset. The table includes key performance indicators (KPIs), including Clicks, Cost per Click (CPC), Cost per Thousand Impressions (CPM), Cost per Purchase (CPP), Click-Through Rate (CTR), Impressions, Reach, and Spend. These metrics are segmented across different placements, including Total, Feed, Video Feeds, and a Social Media Platform, allowing for granular analysis of asset performance in distinct delivery contexts.

The example of FIG. 17 shows that while the overall campaign generated 195 clicks, only 4 clicks originated from Feed placements and 2 from the Social Media Platform, with Video Feeds yielding no clicks. Similarly, CPC and CPM values vary significantly across placements, indicating differing cost efficiencies. This level of granularity supports the ability to normalize performance across heterogeneous placements and channels, and to generate insights into which combinations of creative, placement, and audience yield optimal results.

To enable a user to understand which channel, placement, and/or audience is working and which is not, some embodiments aggregate the asset performance at those levels. Specifically, some embodiments normalize the performance across creative assets into a quantitative score.

FIGS. 18A and 18B illustrate an example of normalization for a creative asset, according to some embodiments. FIG. 18A shows a user interface 1800 that is similar to the embodiments of the user interfaces described above with respect to FIGS. 13, 14C and 16A-E, respectively, and like reference numbers have been used to refer to the same or similar components. A detailed description of some components has been omitted, and the following discussion focuses on the differences between these embodiments. Any of the various features discussed with any one of the embodiments discussed herein may also apply to and be used with any other embodiments.

FIG. 18A shows the user interface 1800 having 4 user-defined thresholds T1, T2, T3, and T4. These thresholds separate the color scale into five performance bands: dark green, light green, yellow, light red, and dark red. This example has four sliders 1855a, 1855b, 1855c, and 1855d to adjust the thresholds for CTR. Each performance band is defined with respect to the thresholds, and may be assigned interpretations and normalized scores, as summarized in Table 1.

TABLE 1

| Color | | | | |
|---|---|---|---|---|
| (Performance | | | | Normalized |
| Band) | Performance | Interpretation | Value | Score |
| Dark Red | Very poor | The creative | <T1 | <−1 |
| | performance | asset missed | | |
| | | performance | | |
| | | badly | | |
| Light Red | Poor | The creative | T1-T2 | −1 to 0 |
| | performance | asset missed | | |
| | | performance | | |
| Yellow | Average | The creative | T2-T3 | 0 to 0.5 |
| | Performance | asset just | | |
| | | started to work | | |
| | | (acceptable) | | |
| Light Green | Good | The creative | T3-T4 | 0.5 to 1 |
| | Performance | asset is | | |
| | | performing | | |
| Dark Green | Very Good | The creative | >T4 | >1 |
| | Performance | asset is | | |
| | | performing very | | |
| | | well | | |

As shown in FIG. 18B, values may be assigned to each threshold based on the normalized scores defined in Table 1. In some embodiments, calculating the performance score of a particular asset may be achieved by measuring how much of a particular performance band has the asset covered. A non-limiting example of a performance score calculation is now described using CTR as a metric.

$$For Dark Red , Score = - 1 + ( ( V - T 1 ) / ( T 1 ) )$$

$$If CTR = 1 \% , then Score = - 1 + ( ( 1 - 2 ) / 2 ) = - 1.5$$

$$If CTR is 0 \% , then Score = - 1 + ( ( 0 - 2 ) / 2 ) = - 2$$

$$For Light Red , Score = - 1 + ( ( V - T 1 ) / ( T 2 - T 1 ) )$$

$$If CTR is 3 \% , Score = - 1 + ( 3 - 2 ) / ( 5 - 2 ) = - 0.667$$

$$For Yellow , Score = 0.5 * ( ( V - T 2 ) / ( T 3 - T 2 )$$

$$If CTR is 5.6 \% , Score = 0.5 * ( ( 5.6 - 5 ) / ( 6 - 5 ) ) = 0.3$$

$$For Light Green , Score = 0.5 + 0.5 * ( ( V - T 3 ) / ( T 4 - T 3 ) )$$

$$If CTR is 7 \% , Score = 0.5 + 0.5 * ( ( 7 - 6 ) / ( 10 - 6 ) ) = 0.625$$

$$For Dark Green , Score = 1 + ( V - T 4 ) / ( T 4 )$$

$$If CTR is 12 \% , Score = 1 + ( 12 - 10 ) / 10 = 1.2$$

$$If CTR is 20 \% , Score = 1 + ( 20 - 10 ) / 10 = 2$$

If a creative asset uses multiple KPIs, then the performance score of one of the KPIs (e.g., the prominent KPI) or a combination of the performance scores from some or all of the KPIs (e.g., a weighted sum) may be used for decision making.

Once the creative asset performance has been normalized to a performance score, a combination (e.g., an average, a median, a mean, or some other combination) of all performance scores may be used when comparing groups. In some embodiments, the system enables comparative analysis of marketing performance across different types of groups, including but not limited to platforms, channels, marketers, agencies, etc., by aggregating normalized performance scores for creative assets associated with each group.

Consider an example comparing marketing agencies (or any other construct, e.g., accounts, users, etc.). If Agency A created 50 creative assets with an average performance score of 0.9, and Agency B created 5 creative assets with an average performance score of 1.2, then Agency B outperformed Agency A because of the higher average performance score.

As another example, consider an example where two platforms are being compared (e.g., a Social Media Platform and a Video Sharing Website). If the Social Media Platform (SMP) has 50 creative assets with an average performance score=0.6, and the Video Sharing Website (VSW) has 10 creative assets with an average performance score=0.85, then VSW has a better performance because of the higher average performance score.

In some embodiments, heatmaps may be generated to evaluate different agencies, user groups, or any other aggregation or group. Heatmaps may be used to evaluate and compare marketing agencies, channels, campaigns, platforms, and any other desired group of creative assets.

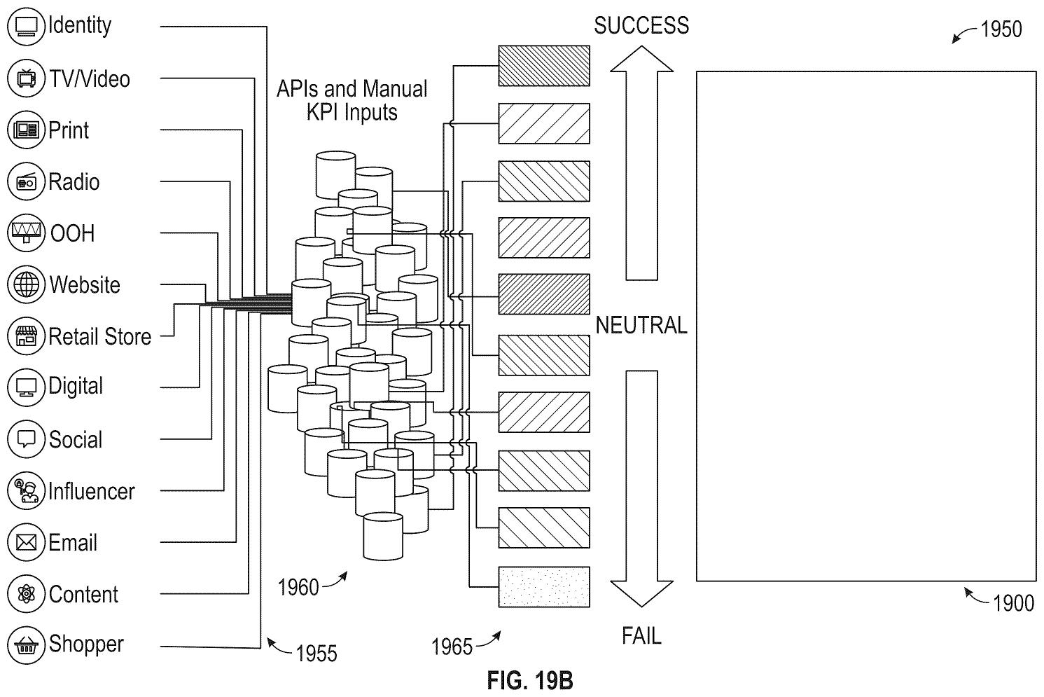

FIG. 19A illustrates a heatmap 1900 of marketing channels, according to some embodiments. The heatmap 1900 is similar to the embodiment of the diagrams 1000 and 1100 described above with respect to FIG. 10 and FIG. 11, respectively, and like reference numbers have been used to refer to the same or similar components. A detailed description of some components has been omitted, and the following discussion focuses on the differences between these embodiments. Any of the various features discussed with any one of the embodiments discussed herein may also apply to and be used with any other embodiments.

In this example, the channels are organized into three domains: non-digital channels 1910, digital channels 1920, and data producing channels 1930. Each channel may be a marketing input that some embodiments may ingest, normalize, and analyze to generate insights into the performance of creative assets. Each channel may represent a marketing input that some embodiments may ingest, normalize, and analyze to assess performance of creative assets across multiple dimensions.

Each channel is represented on the heatmap 1900 with a color indicator corresponding to a normalized performance score. For example, green represents higher performance relative to KPI benchmarks, yellow represents neutral or average performance, and red represents underperformance. Gray denotes inactive or missing channels. This visual representation allows users to quickly identify which channels are performing well and which channels may require optimization.

The heatmap 1900 is similar in some respects to color indicator 1500 described above with respect to FIG. 15, but instead of individual creative assets, the heatmap 1900 aggregates and displays channel-level performance. Similar threshold logic used for asset-level scoring (e.g., as described above with respect to FIGS. 14A-C, 16A-E, and 18A-B) may be applied to the channel performance values, enabling meaningful performance evaluation across any number of marketing channels.

In some embodiments, a user interface (not shown) for the heatmap 1900 may include filtering controls for narrowing the view by one or more of a category, a platform, a type, a status, a performance level, and other factors. The user interface may also support dynamic resizing and date range selection.

FIG. 19B is a diagram 1950 illustrating the use of a normalized KPI framework to generate the heatmap 1900 shown in FIG. 19A, according to some embodiments. In particular, FIG. 19B depicts how heterogeneous marketing inputs 1955 are ingested and transformed into the normalized performance scoring that drives the visualization of FIG. 19A.

As shown, multiple categories of marketing channels, including but not limited to identity, TV/video, print, radio, out-of-home (OOH), website, retail store, digital, social, influencer, email, content, and shopper inputs, may be used to create inputs 1960. These inputs may be ingested through application programming interfaces (APIs) or manual entries. The inputs are stored, processed, and normalized into a standardized KPI success spectrum 1965 ranging from success (green) to failure (red), with intermediate neutral states.

The right-hand side of FIG. 19B includes the heatmap 1900 of FIG. 19A. The heatmap 1900 represents the output of the KPI normalization process, where each marketing channel is assigned a performance score and visualized with a corresponding color indicator.

Some embodiments may further incorporate artificial intelligence and semantic search models to process the normalized data and generate predictive insights. By applying AI-driven classification and semantic enrichment, the heatmap 1900 of FIG. 19A becomes not only a snapshot of current asset performance but also a basis for forecasting and prescriptive recommendations across channels, platforms, and other groupings.

### External Factors

External factors (e.g., weather, consumer confidence index, social media trends, etc.) may impact marketing performance. Some embodiments may further ingest external data points, including but not limited to weather, social media trends, consumer confidence index, or any other metric that may be of relevance to the customer. Performance may be aggregated based on these external factors, in a similar manner to aggregation of performance for various platforms and channels as described above (e.g., heatmap 1900).

As an example, if it is raining heavily, no matter how well a movie is advertised using creative assets, people may not go to the theater to watch the movie. The performance as measured by a KPI (e.g., ticket sales) may be correlated with weather (rain forecast, precipitation, etc.). In such a scenario, the user may aggregate asset performance by “amount of rain on the day of ticket sale.” This enables the user to understand which external factors are relevant to marketing performance.

### Machine Learning Trained Models

Some embodiments utilize machine learning (e.g., artificial intelligence) to train various models that analyze historical marketing performance data and learn correlations between input features and normalized performance scores (as described above). The output of the model may be a predicted normalized performance score, which may be mapped to a color-coded scale as described above for intuitive visualization and strategic decision-making. Some embodiments may visualize these recommendations using heatmaps (e.g., color indicator 1500 as described in FIG. 15, heatmap 1900 as described in FIG. 19A-B, etc.) to help users interpret and compare options across marketing categories, groups, placements, channels, and the like.

Input features may include, but are not limited to, attributes and format of the creative asset (e.g., video, static image, carousel, interactive, etc.), metadata such as aspect ratio and video length, and visual design elements including layout, color palette, brand elements, and use of imagery or typography. Messaging features such as tone, clarity, emotional resonance, and call-to-action effectiveness may also be considered. Some embodiments may extract latent features using vector embeddings, to automatically capture nuanced features in creative assets without requiring manual feature definition.

In some embodiments, placement-related input features may include (but are not limited to) the marketing channel for content delivery (e.g., Facebook, Instagram, LinkedIn, YouTube, TV, Radio, etc.), whether the content is paid or organic, the specific placement location (e.g., feed, banner, search result, etc.), timing attributes (e.g., day of week, time of day, seasonal relevance, etc.), and audience demographics (e.g., age, gender, geographic location, household income, interests, etc.). Campaign objectives may also be encoded, such as whether the campaign is focused on retention, awareness, cross-selling, conversion, etc.

In some embodiments, external input features may encompass environmental and market conditions that may influence campaign performance. These may include, but are not limited to, weather data (e.g., temperature, precipitation, etc.—factors that affect mood and behavior), news and social trends (e.g., viral content, pop culture, social movements, etc.), economic indicators (e.g., inflation, interest rates, unemployment, etc.), consumer sentiment (e.g., survey data, market sentiment, etc.), and competitor activity (e.g., promotions, creative launches, etc. by competitors). Additional features may be incorporated based on the specific industry or vertical.

### Predicting Performance

Some embodiments provide predictive models to predict how well a particular creative asset, placement, or marketing context will perform. Over time, the predictive model may learn to associate marketing input features (as described above) with performance outcomes, enabling the model to forecast whether a given asset is likely to be classified as high-performing (e.g., green), moderate-performing (e.g., yellow), or low-performing (e.g., red).

In some embodiments, the trained models may use any combination of the input features described above to generate a predicted performance score for a creative asset, placement, or campaign scenario. The predicted performance score may be used to inform creative asset selection, campaign planning, and optimization strategies. The trained machine learning model may also be used in conjunction with heatmaps (e.g., color indicator 1500 as described in FIG. 15, heatmap 1900 as described in FIG. 19A-B, etc.) to visualize predicted performance, thereby enabling marketers to make data-driven decisions and improve return on ad spend (ROAS).

### Prescribing Marketing Strategies

Some embodiments provide a prescriptive model that is trained to recommend and/or optimize creative strategies for a given marketing scenario. The prescriptive model may utilize the same set of input features as the predictive model of some embodiments described above (e.g., creative attributes, placement metadata, audience characteristics, and external factors, etc.) to determine what kind of creative asset is most likely to succeed for a particular product, placement, and campaign objective. The goal may be to maximize marketing impact, performance, and return on ad spend (ROAS).

Some embodiments enable users to interact with the prescriptive model through a query interface, allowing them to explore and refine campaign strategies. A user may input parameters such as product type, target audience demographics, campaign objectives (e.g., awareness, retention, conversion, etc.), budget constraints, and external conditions (e.g., seasonality, economic indicators, etc.). In response, the prescriptive model may provide recommendations on various actions, including but not limited to: what type of creative asset format is likely to perform best and why; which placement channels and timing windows are optimal for delivery; which audience segments are most responsive to the proposed campaign; and how to adjust and optimize campaign variables to improve performance outcomes.

Some embodiments provide a generative model that is trained to suggest and/or generate new creative assets. This generative model leverages learned relationships between input features and performance outcomes to tailor suggestions and generated creative assets to specific campaign parameters. For example, given one or more of a product category, target audience, campaign objective, budget, and/or external context, the system may generate one or more recommended ad formats with suggested imagery, messaging tone, layout, and the like. These generative outputs may be used to accelerate creative asset development, reduce reliance on manual design, and ensure alignment with data-driven performance benchmarks.

Together, the prescriptive and generative components of various embodiments as described above may transform historical marketing data into actionable intelligence, enabling marketers to make informed decisions and continuously optimize their strategies across channels, placements, and audience segments.

In some embodiments, the machine learning models described herein may be continuously retrained or fine-tuned based on observed campaign outcomes, such as conversion rates, click-through rates, engagement levels, or other performance metrics. This iterative training process may create a feedback loop in which actual performance data is used to refine model weights and parameters, thereby improving predictive accuracy over time. In some cases, multiple models may be employed in parallel or in sequence, such as an ensemble of classifiers for performance scoring combined with a reinforcement learning model for optimization of campaign strategy. The models may be implemented using supervised learning, unsupervised learning, reinforcement learning, or deep learning architectures such as neural networks, decision trees, ensemble methods, or transformer-based models, without limitation.

In some embodiments, the system may further provide confidence scores, probability distributions, or explainability indicators alongside predicted or recommended outputs. For example, a prescriptive recommendation may include not only the suggested creative asset and placement but also an explanation of the input features most influential in the recommendation (e.g., audience demographics, time of day, color palette, etc.). Generative outputs may be produced in multiple modalities, including text (e.g., headlines or calls-to-action), imagery (e.g., layouts or color schemes), and video templates, and may be automatically ranked or scored according to predicted performance prior to presentation. Heatmaps may be employed not only for visualizing historical or predicted asset performance, but also for simulating “what-if” scenarios in which hypothetical assets or placements are evaluated and color-coded according to model outputs, thereby extending the heatmap as both a diagnostic and forward-looking planning tool.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

The accompanying appendix, which is included to provide further understanding of the subject technology and is incorporated in and constitutes a part of this specification, illustrates aspects of the subject technology and together with the description serves to explain the principles of the subject technology.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method for optimizing performance of creative assets, comprising:
receiving historical marketing data comprising a plurality of historical creative assets and historical performance data associated with the plurality of historical creative assets;
processing the historical marketing data to identify a plurality of input features associated with the historical creative assets;
using the identified plurality of input features and the historical performance data, training a machine learning model, thereby generating a trained marketing model conditioned to the input features and the historical performance data;
providing as an input to the trained marketing model, marketing data comprising at least one creative asset, a selection of at least one marketing channel for placement of the at least one creative asset therein, and one or more performance indicators for evaluating performance of the at least one creative asset; and
receiving as an output from the trained marketing model, predicted values for the one or more performance indicators upon placement of the at least one creative asset on the at least one marketing channel.

2. The method of claim 1, further comprising:
providing, as another input to the trained marketing model, target values for the one or more performance indicators; and
receiving, as another output from the trained marketing model, a recommendation from a repository of available creative assets of one or more predefined creative assets that are predicted to achieve the target values of the one or more performance indicators upon placement of the one or more predefined creative assets on the at least one marketing channel.

3. The method of claim 1, further comprising:
providing, as another input to the trained marketing model, target values for the one or more performance indicators; and
receiving, as another output from the trained marketing model, a recommendation of a marketing channel for placement of the at least one creative asset to achieve the target values of the one or more performance indicators.

4. The method of claim 1, further comprising:
providing, as another input to the trained marketing model, target values for the one or more performance indicators; and
receiving, as another output from the trained marketing model, a recommendation of advertising campaign parameters, the advertising campaign parameters comprising at least one of timing parameters, audience parameters, budget parameters, or any combination thereof, wherein the advertising campaign parameters are predicted to achieve the target values of the one or more performance indicators during placement of the at least one creative asset on the at least one marketing channel.

5. The method of claim 1, wherein the identified plurality of input features comprise at least one of a plurality of creative features, a plurality of placement features, a plurality of external features, or any combination thereof.

6. The method of claim 5, wherein the plurality of creative features comprise at least one of attributes of the creative asset, format of the creative asset, metadata of the creative asset, design elements of the creative asset, content of the creative asset, or any combination thereof.

7. The method of claim 5, wherein the plurality of placement features comprise at least one of marketing channel, content type, placement location, timing attributes, audience demographics, campaign objectives, or any combination thereof.

8. The method of claim 1, further comprising:
identifying a plurality of external features associated with the historical creative assets; and
further using the identified plurality of external features to train the machine learning model, wherein the trained marketing model is further conditioned to the external features.

9. The method of claim 8, wherein the identified plurality of external features comprise at least one of environmental conditions, market conditions, weather data, news information, social trends, economic indicators, consumer sentiment, competitor activity, or any combination thereof.

10. The method of claim 1, further comprising:
providing, as another input to the trained marketing model, target values for the one or more performance indicators; and
generating, using the trained marketing model, at least one new creative asset that is predicted to achieve the target values of the one or more performance indicators upon placement of the at least one new creative asset on the at least one marketing channel.

11. The method of claim 2, wherein the selection of at least one marketing channel is from a plurality of marketing channels comprising digital channels, non-digital channels, data-producing channels, or any combination thereof.

12. The method of claim 1, wherein the historical performance data comprises performance measurements for a plurality of historical performance indicators, the method further comprising:
normalizing the performance measurements to a standardized range; and
further using the normalized performance measurements to train the machine learning model, wherein the trained marketing model is further conditioned to the normalized performance measurements.

13. The method of claim 12, further comprising:
defining a plurality of thresholds associated with the standardized scale; and
mapping the plurality of thresholds to a range of color values.

14. A non-transitory computer-readable medium storing a program for optimizing performance of creative assets, which when executed by a computer, configures the computer to:
receive historical marketing data comprising a plurality of historical creative assets and historical performance data associated with the plurality of historical creative assets;
process the historical marketing data to identify a plurality of input features associated with the historical creative assets;
use the identified plurality of input features and the historical performance data to train a machine learning model, thereby generating a trained marketing model conditioned to the input features and the historical performance data;
provide, as an input to the trained marketing model, marketing data comprising at least one creative asset, a selection of at least one marketing channel for placement of the at least one creative asset therein, and one or more performance indicators for evaluating performance of the at least one creative asset; and
receive, as an output from the trained marketing model, predicted values for the one or more performance indicators upon placement of the at least one creative asset on the at least one marketing channel.

15. The non-transitory computer-readable medium of claim 14, wherein the program, when executed by the computer, further configures the computer to:
provide, as another input to the trained marketing model, target values for the one or more performance indicators; and
receive, as another output from the trained marketing model, a recommendation from a repository of available creative assets of one or more predefined creative assets that are predicted to achieve the target values of the one or more performance indicators upon placement of the one or more predefined creative assets on the at least one marketing channel.

16. The non-transitory computer-readable medium of claim 14, wherein the program, when executed by the computer, further configures the computer to:
provide, as another input to the trained marketing model, target values for the one or more performance indicators; and
receive, as another output from the trained marketing model, a recommendation of a marketing channel for placement of the at least one creative asset to achieve the target values of the one or more performance indicators.

17. The non-transitory computer-readable medium of claim 14, wherein the program, when executed by the computer, further configures the computer to:
provide, as another input to the trained marketing model, target values for the one or more performance indicators; and
receive, as another output from the trained marketing model, a recommendation of advertising campaign parameters, the advertising campaign parameters comprising at least one of timing parameters, audience parameters, budget parameters, or any combination thereof, wherein the advertising campaign parameters are predicted to achieve the target values of the one or more performance indicators during placement of the at least one creative asset on the at least one marketing channel.

18. The non-transitory computer-readable medium of claim 14, wherein the program, when executed by the computer, further configures the computer to:
identify a plurality of external features associated with the historical creative assets; and
further use the identified plurality of external features to train the machine learning model, wherein the trained marketing model is further conditioned to the external features.

19. The non-transitory computer-readable medium of claim 14, wherein the program, when executed by the computer, further configures the computer to:
provide, as another input to the trained marketing model, target values for the one or more performance indicators; and
generate, using the trained marketing model, at least one new creative asset that is predicted to achieve the target values of the one or more performance indicators upon placement of the at least one new creative asset on the at least one marketing channel,
wherein the selection of at least one marketing channel is from a plurality of marketing channels comprising digital channels, non-digital channels, data-producing channels, or any combination thereof.

20. The non-transitory computer-readable medium of claim 14, wherein the historical performance data comprises performance measurements for a plurality of historical performance indicators, and the program, when executed by the computer, further configures the computer to:
normalize the performance measurements to a standardized range;
further use the normalized performance measurements to train the machine learning model, wherein the trained marketing model is further conditioned to the normalized performance measurements;
define a plurality of thresholds associated with the standardized scale; and
map the plurality of thresholds to a range of color values.

21. A system for optimizing performance of creative assets, comprising:
one or more processors; and
a non-transitory computer-readable medium storing a set of instructions, which when executed by at least one of the one or more processors, configure the system to:
receive historical marketing data comprising a plurality of historical creative assets and historical performance data associated with the plurality of historical creative assets;
process the historical marketing data to identify a plurality of input features associated with the historical creative assets;
use the identified plurality of input features and the historical performance data to train a machine learning model, thereby generating a trained marketing model conditioned to the input features and the historical performance data;
provide, as an input to the trained marketing model, marketing data comprising at least one creative asset, a selection of at least one marketing channel for placement of the at least one creative asset therein, and one or more performance indicators for evaluating performance of the at least one creative asset; and
receive, as an output from the trained marketing model, predicted values for the one or more performance indicators upon placement of the at least one creative asset on the at least one marketing channel.
